(19) United States
(12) Patent Application Publication
(10) Pub. No.: US 2026/0255188 A1
(43) Pub. Date: Aug. 27, 2026

(54) TECHNIQUES FOR MITIGATING MOTOR FAILURE FOR DEVICES WITH MECHANICALLY DISPLACEABLE ANTENNA PANELS

(71) Applicant: QUALCOMM Incorporated, San Diego, CA (US)

(72) Inventors: Vasanthan RAGHAVAN, West Windsor Township, NJ (US); Yu-Chin OU, San Diego, CA (US); Junyi LI, Greentown, PA (US); Jung Ho RYU, Englewood Cliffs, NJ (US)

(21) Appl. No.: 19/061,995

(22) Filed: Feb. 24, 2025

(51) Int. Cl. H04W 24/04; H01Q 3/04; H04B 7/06; H04W 8/24; H04W 28/02

(52) U.S. Cl. CPC H04W 24/04; H01Q 3/04; H04B 7/0617; H04B 7/0628; H04W 8/24; H04W 28/0221

(57) ABSTRACT

Methods, systems, and devices for wireless communications are described. A wireless device, such as a customer premises equipment (CPE), may transmit a first capability message indicating a first set of communication parameters associated with one or more mechanically-displaceable antenna panels of the wireless device. The wireless device may then communicate during a first time interval in accordance with the first set of communication parameters. Subsequently, upon identifying a change/degradation in the communication parameters, the wireless device may transmit a second capability message indicating a second set of communication parameters associated with one or more mechanically-displaceable antenna panels. The wireless device may then communicate during a second time interval in accordance with the second set of communication parameters. Thus, the wireless device may dynamically update communication parameters based on the mechanical degradation of the mechanically-displaceable antenna panels.

### FIELD OF TECHNOLOGY

The following relates to wireless communications, including techniques for mitigating motor failure for devices with mechanically displaceable antenna panels.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless devices, such as low-cost customer premises equipment (CPE), may use mechanically-displaceable antenna panels in order to perform communications. That is, some wireless devices may use motors and other actuators to physically move/displace such mechanically-displaceable antenna panels in order to communicate in various directions and/or perform various beamforming functions. The antenna panels may be moved linearly/laterally and/or radially. However, the mechanical-displacement capabilities of the antenna panels may degrade or deteriorate over time, which may affect the communications capabilities of the CPE.

### SUMMARY

The systems, methods, and devices of this disclosure each have several innovative aspects, no single one of which is solely responsible for the desirable attributes disclosed herein.

A method by a first wireless device is described. The method may include transmitting, to a second wireless device, a first capability message indicating a first set of communication parameters associated with one or more mechanically-displaceable antenna panels of the first wireless device, communicating, during a first time interval, with the second wireless device using the one or more mechanically-displaceable antenna panels and in accordance with the first set of communication parameters, transmitting, to the second wireless device, a second capability message indicating a second set of communication parameters associated with one or more mechanically-displaceable antenna panels, where at least one communication parameter of the second set of communication parameters is degraded relative to the first set of communication parameters based on a mechanical degradation of the one or more mechanically-displaceable antenna panels, and communicating, during a second time interval, with the second wireless device using the one or more mechanically-displaceable antenna panels and in accordance with the second set of communication parameters.

A first wireless device is described. The first wireless device may include one or more memories storing processor executable code, and one or more processors coupled with the one or more memories. The one or more processors may individually or collectively be operable to execute the code to cause the first wireless device to transmit, to a second wireless device, a first capability message indicating a first set of communication parameters associated with one or more mechanically-displaceable antenna panels of the first wireless device, communicate, during a first time interval, with the second wireless device using the one or more mechanically-displaceable antenna panels and in accordance with the first set of communication parameters, transmit, to the second wireless device, a second capability message indicating a second set of communication parameters associated with one or more mechanically-displaceable antenna panels, where at least one communication parameter of the second set of communication parameters is degraded relative to the first set of communication parameters based on a mechanical degradation of the one or more mechanically-displaceable antenna panels, and communicate, during a second time interval, with the second wireless device using the one or more mechanically-displaceable antenna panels and in accordance with the second set of communication parameters.

Another first wireless device is described. The first wireless device may include means for transmitting, to a second wireless device, a first capability message indicating a first set of communication parameters associated with one or more mechanically-displaceable antenna panels of the first wireless device, means for communicating, during a first time interval, with the second wireless device using the one or more mechanically-displaceable antenna panels and in accordance with the first set of communication parameters, means for transmitting, to the second wireless device, a second capability message indicating a second set of communication parameters associated with one or more mechanically-displaceable antenna panels, where at least one communication parameter of the second set of communication parameters is degraded relative to the first set of communication parameters based on a mechanical degradation of the one or more mechanically-displaceable antenna panels, and means for communicating, during a second time interval, with the second wireless device using the one or more mechanically-displaceable antenna panels and in accordance with the second set of communication parameters.

A non-transitory computer-readable medium storing code is described. The code may include instructions executable by one or more processors to transmit, to a second wireless device, a first capability message indicating a first set of communication parameters associated with one or more mechanically-displaceable antenna panels of the first wireless device, communicate, during a first time interval, with the second wireless device using the one or more mechanically-displaceable antenna panels and in accordance with the first set of communication parameters, transmit, to the second wireless device, a second capability message indicating a second set of communication parameters associated with one or more mechanically-displaceable antenna panels, where at least one communication parameter of the second set of communication parameters is degraded relative to the first set of communication parameters based on a mechanical degradation of the one or more mechanically-displaceable antenna panels, and communicate, during a second time interval, with the second wireless device using the one or more mechanically-displaceable antenna panels and in accordance with the second set of communication parameters.

Some examples of the method, first wireless devices, and non-transitory computer-readable medium described herein may further include operations, features, means, or instructions for receiving, from the second wireless device in response to the second capability message, a control message indicating a modified set of TCI states, where communicating during the second time interval may be performed in accordance with the modified set of TCI states.

In some examples of the method, first wireless devices, and non-transitory computer-readable medium described herein, the second set of communication parameters includes a displacement duration for actuating the one or more mechanically-displaceable antenna panels and the method, apparatuses, and non-transitory computer-readable medium may include further operations, features, means, or instructions for receiving, from the second wireless device in response to the second capability message, control signaling including scheduling information for one or more communications to be performed by the first wireless device during the second time interval, where the scheduling information may be based on the displacement duration for actuating the one or more mechanically-displaceable antenna panels.

In some examples of the method, first wireless devices, and non-transitory computer-readable medium described herein, the one or more communications associated with the scheduling information include at least a first communication and a second communication and a duration between the first communication and the second communication may be based on the displacement duration for actuating the one or more mechanically-displaceable antenna panels.

In some examples of the method, first wireless devices, and non-transitory computer-readable medium described herein, the first set of communication parameters and the second set of communication parameters include a first power consumption and a second power consumption associated with the one or more mechanically-displaceable antenna panels, respectively, the second power consumption may be greater than the first power consumption, communicating during the first time interval may be associated with a first quantity or magnitude of mechanical displacements of the one or more mechanically-displaceable antenna panels, and communicating during the second time interval may be associated with a second quantity or magnitude of mechanical displacements of the one or more mechanically-displaceable antenna panels that may be less than the first quantity or magnitude of mechanical displacements based on the second power consumption being greater than the first power consumption.

In some examples of the method, first wireless devices, and non-transitory computer-readable medium described herein, the first set of communication parameters, the second set of communication parameters, or both, include a range of scan angles of the one or more mechanically-displaceable antenna panels, a linear displacement range of the one or more mechanically-displaceable antenna panels, a displacement duration for actuating the one or more mechanically-displaceable antenna panels, a power consumption associated with the one or more mechanically-displaceable antenna panels, a beamforming capability of the one or more mechanically-displaceable antenna panels, or any combination thereof.

Some examples of the method, first wireless devices, and non-transitory computer-readable medium described herein may further include operations, features, means, or instructions for receiving, from the second wireless device in response to the second capability message, a control message indicating a modified beamforming codebook, where communicating during the second time interval may be performed in accordance with the modified beamforming codebook.

In some examples of the method, first wireless devices, and non-transitory computer-readable medium described herein, the second set of communication parameters includes a coherent beamforming capability of the one or more mechanically-displaceable antenna panels, one or more beamforming gains associated with the one or more mechanically-displaceable antenna panels, or both.

Some examples of the method, first wireless devices, and non-transitory computer-readable medium described herein may further include operations, features, means, or instructions for identifying a change of the first set of communication parameters to the second set of communication parameters based on the mechanical degradation of the one or more mechanically-displaceable antenna panels, where transmitting the second capability message may be based on identifying the change.

Some examples of the method, first wireless devices, and non-transitory computer-readable medium described herein may further include operations, features, means, or instructions for identifying a change of a first communication parameter of the first set of communication parameters to a second communication parameter, the second communication parameter included within the second set of communication parameters, where transmitting the second capability message may be based on the change satisfying a deviation threshold.

In some examples of the method, first wireless devices, and non-transitory computer-readable medium described herein, the first wireless device includes a CPE, a UE, or both.

A method by a second wireless device is described. The method may include receiving, from a first wireless device, a first capability message indicating a first set of communication parameters associated with one or more mechanically-displaceable antenna panels of the first wireless device, communicating, during a first time interval, with the first wireless device in accordance with the first set of communication parameters, receiving, from the first wireless device, a second capability message indicating a second set of communication parameters associated with one or more mechanically-displaceable antenna panels, where at least one communication parameter of the second set of communication parameters is degraded relative to the first set of communication parameters based on a mechanical degradation of the one or more mechanically-displaceable antenna panels, and communicating, during a second time interval, with the first wireless device in accordance with the second set of communication parameters.

A second wireless device is described. The second wireless device may include one or more memories storing processor executable code, and one or more processors coupled with the one or more memories. The one or more processors may individually or collectively be operable to execute the code to cause the second wireless device to receive, from a first wireless device, a first capability message indicating a first set of communication parameters associated with one or more mechanically-displaceable antenna panels of the first wireless device, communicate, during a first time interval, with the first wireless device in accordance with the first set of communication parameters, receive, from the first wireless device, a second capability message indicating a second set of communication parameters associated with one or more mechanically-displaceable antenna panels, where at least one communication parameter of the second set of communication parameters is degraded relative to the first set of communication parameters based on a mechanical degradation of the one or more mechanically-displaceable antenna panels, and communicate, during a second time interval, with the first wireless device in accordance with the second set of communication parameters.

Another second wireless device is described. The second wireless device may include means for receiving, from a first wireless device, a first capability message indicating a first set of communication parameters associated with one or more mechanically-displaceable antenna panels of the first wireless device, means for communicating, during a first time interval, with the first wireless device in accordance with the first set of communication parameters, means for receiving, from the first wireless device, a second capability message indicating a second set of communication parameters associated with one or more mechanically-displaceable antenna panels, where at least one communication parameter of the second set of communication parameters is degraded relative to the first set of communication parameters based on a mechanical degradation of the one or more mechanically-displaceable antenna panels, and means for communicating, during a second time interval, with the first wireless device in accordance with the second set of communication parameters.

A non-transitory computer-readable medium storing code is described. The code may include instructions executable by one or more processors to receive, from a first wireless device, a first capability message indicating a first set of communication parameters associated with one or more mechanically-displaceable antenna panels of the first wireless device, communicate, during a first time interval, with the first wireless device in accordance with the first set of communication parameters, receive, from the first wireless device, a second capability message indicating a second set of communication parameters associated with one or more mechanically-displaceable antenna panels, where at least one communication parameter of the second set of communication parameters is degraded relative to the first set of communication parameters based on a mechanical degradation of the one or more mechanically-displaceable antenna panels, and communicate, during a second time interval, with the first wireless device in accordance with the second set of communication parameters.

In some examples of the method, second wireless devices, and non-transitory computer-readable medium described herein, the method, apparatuses, and non-transitory computer-readable medium may include further operations, features, means, or instructions for transmitting, to the first wireless device in response to the second capability message, a control message indicating a modified set of TCI states, where communicating during the second time interval may be performed in accordance with the modified set of TCI states.

In some examples of the method, second wireless devices, and non-transitory computer-readable medium described herein, the second set of communication parameters includes a displacement duration for actuating the one or more mechanically-displaceable antenna panels and the method, apparatuses, and non-transitory computer-readable medium may include further operations, features, means, or instructions for transmitting, to the first wireless device in response to the second capability message, control signaling including scheduling information for one or more communications to be performed by the first wireless device during the second time interval, where the scheduling information may be based on the displacement duration for actuating the one or more mechanically-displaceable antenna panels.

In some examples of the method, second wireless devices, and non-transitory computer-readable medium described herein, the one or more communications associated with the scheduling information include at least a first communication and a second communication and a duration between the first communication and the second communication may be based on the displacement duration for actuating the one or more mechanically-displaceable antenna panels.

In some examples of the method, second wireless devices, and non-transitory computer-readable medium described herein, the first set of communication parameters and the second set of communication parameters include a first power consumption and a second power consumption associated with the one or more mechanically-displaceable antenna panels, respectively, the second power consumption may be greater than the first power consumption, communicating during the first time interval may be associated with a first quantity or magnitude of mechanical displacements of the one or more mechanically-displaceable antenna panels, and communicating during the second time interval may be associated with a second quantity or magnitude of mechanical displacements of the one or more mechanically-displaceable antenna panels that may be less than the first quantity or magnitude of mechanical displacements based on the second power consumption being greater than the first power consumption.

In some examples of the method, second wireless devices, and non-transitory computer-readable medium described herein, the first set of communication parameters, the second set of communication parameters, or both, include a range of scan angles of the one or more mechanically-displaceable antenna panels, a linear displacement range of the one or more mechanically-displaceable antenna panels, a displacement duration for actuating the one or more mechanically-displaceable antenna panels, a power consumption associated with the one or more mechanically-displaceable antenna panels, a beamforming capability of the one or more mechanically-displaceable antenna panels, or any combination thereof.

In some examples of the method, second wireless devices, and non-transitory computer-readable medium described herein, the second capability message indicates an inability of the first wireless device to communicate in accordance with at least a portion of the beamforming codebook and the method, apparatuses, and non-transitory computer-readable medium may include further operations, features, means, or instructions for transmitting, to the first wireless device in response to the second capability message, a control message indicating a modified beamforming codebook, where communicating during the second time interval may be performed in accordance with the modified beamforming codebook.

In some examples of the method, second wireless devices, and non-transitory computer-readable medium described herein, the second set of communication parameters includes a coherent beamforming capability of the one or more mechanically-displaceable antenna panels, one or more beamforming gains associated with the one or more mechanically-displaceable antenna panels, or both.

In some examples of the method, second wireless devices, and non-transitory computer-readable medium described herein, the first wireless device includes a CPE, a UE, or both.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for mitigating motor failure for devices with mechanically displaceable antenna panels in accordance with one or more aspects of the present disclosure.

FIG. 2 shows an example of a wireless communications system that supports techniques for mitigating motor failure for devices with mechanically displaceable antenna panels in accordance with one or more aspects of the present disclosure.

FIG. 3 shows an example of a process flow that supports techniques for mitigating motor failure for devices with mechanically displaceable antenna panels in accordance with one or more aspects of the present disclosure.

FIGS. 4 and 5 show block diagrams of devices that support techniques for mitigating motor failure for devices with mechanically displaceable antenna panels in accordance with one or more aspects of the present disclosure.

FIG. 6 shows a block diagram of a communications manager that supports techniques for mitigating motor failure for devices with mechanically displaceable antenna panels in accordance with one or more aspects of the present disclosure.

FIG. 7 shows a diagram of a system including a device that supports techniques for mitigating motor failure for devices with mechanically displaceable antenna panels in accordance with one or more aspects of the present disclosure.

FIGS. 8 and 9 show block diagrams of devices that support techniques for mitigating motor failure for devices with mechanically displaceable antenna panels in accordance with one or more aspects of the present disclosure.

FIG. 10 shows a block diagram of a communications manager that supports techniques for mitigating motor failure for devices with mechanically displaceable antenna panels in accordance with one or more aspects of the present disclosure.

FIG. 11 shows a diagram of a system including a device that supports techniques for mitigating motor failure for devices with mechanically displaceable antenna panels in accordance with one or more aspects of the present disclosure.

FIGS. 12 and 13 show flowcharts illustrating methods that support techniques for mitigating motor failure for devices with mechanically displaceable antenna panels in accordance with one or more aspects of the present disclosure.

### DETAILED DESCRIPTION

Some wireless devices, such as low-cost customer premises equipment (CPE), may use mechanically-displaceable antenna panels in order to perform communications. That is, some wireless devices may use motors and other actuators to physically move/displace such mechanically-displaceable antenna panels in order to communicate in various directions and/or perform various beamforming functions. The antenna panels may be moved linearly/laterally and/or radially. However, the mechanical-displacement capabilities of the antenna panels may degrade or deteriorate over time, which may affect the communications capabilities of the CPE. For example, as the motors/actuators experience wear over time, the linear and/or angular displacement range over which the antenna panels can be moved may decrease, which may reduce the beamforming capabilities of the CPE, and decrease the angular range over which the CPE can transmit/receive communications. The mechanical degradation of the mechanically-displaceable antenna panels may result in other issues, such as increased time required to move the antenna panels, increased power consumption required to move the antenna panels, increased heat generation resulting from movement of the antenna panels, etc. Taken together, the degradation of the mechanical-displacement capabilities of the antenna panels may detrimentally affect the ability of the CPE to perform wireless communications.

Accordingly, aspects of the present disclosure are directed to signaling mechanisms used by CPEs (and other wireless devices) to report degraded communications capabilities that result from degradation of mechanically-displaceable antenna panels. That is, as motors/actuators used to displace antenna panels degrade over time, the CPE may be configured to report such degraded capabilities so that the network can schedule the CPE to perform communications that may be performed by the CPE despite the degraded capabilities. For instance, upon setup, the CPE with mechanically-displaceable antenna panels may report that it can perform communications with a particular set of beams/TCI states. Subsequently, the CPE may identify a mechanical degradation that affects the ability of the CPE to move/actuate the antenna panels, which impacts the ability of the CPE to perform communications with some of the reported beams/TCI states. By reporting this mechanical degradation (and the impact to the communication capabilities of the CPE), the network can schedule communications at the CPE using the beams/TCI state that are still usable by the CPE.

Techniques described herein may enable wireless devices (e.g., CPEs, UEs) to report communications parameters/capabilities based on the performance of mechanically-displaceable antenna panels. In particular, as the mechanical-displacement capabilities of the mechanically-displaceable antenna panels degrade over time, aspects of the present disclosure may enable the UEs/CPEs to report corresponding communications parameters/capabilities resulting from the current status/capabilities of the mechanically-displaceable antenna panels. As such, techniques described herein may enable the network to tailor communications scheduled to be performed at the UEs/CPEs based on the current status/capabilities of the mechanically-displaceable antenna panels. Therefore, techniques described herein may result in more efficient and reliable wireless communications performed by devices with mechanically-displaceable antenna panels, thereby leading to less retransmissions, less network congestion, more efficient use of resources, and reduced power consumption at the UEs/CPEs.

Aspects of the disclosure are initially described in the context of wireless communications systems. Additional aspects of the disclosure are described in the context of an example process flow. Aspects of the disclosure are further illustrated by and described with reference to apparatus diagrams, system diagrams, and flowcharts that relate to techniques for mitigating motor failure for devices with mechanically displaceable antenna panels.

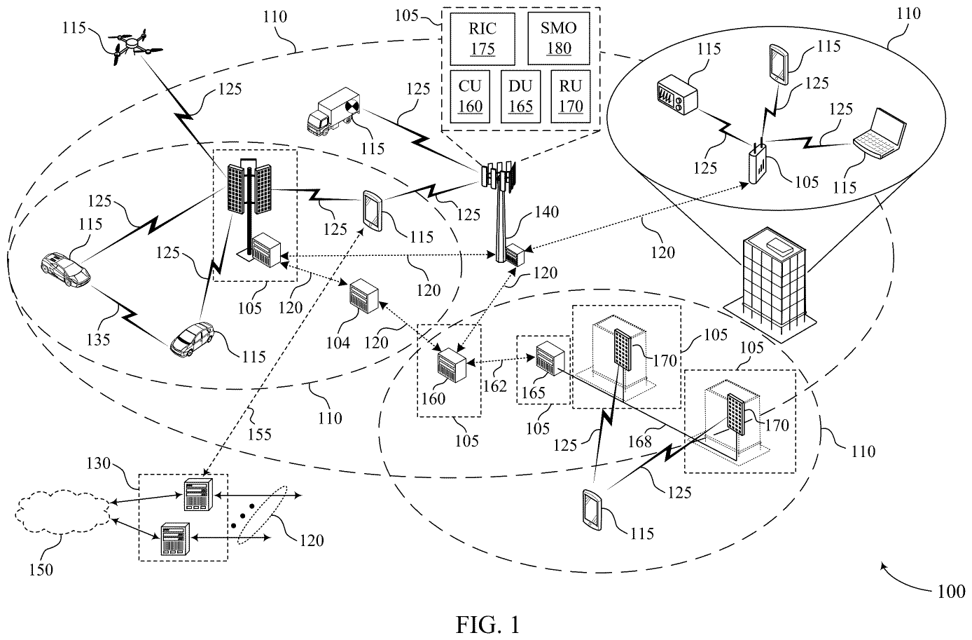

FIG. 1 shows an example of a wireless communications system 100 that supports techniques for mitigating motor failure for devices with mechanically displaceable antenna panels in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support techniques for mitigating motor failure for devices with mechanically displaceable antenna panels as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some aspects, the respective wireless devices of the wireless communications system 100 (e.g., UEs 115, CPEs, network entities 105, IoT devices, IAB nodes, etc.) may support signaling mechanisms used by UEs 115, CPEs, and other wireless devices, to report degraded communications capabilities that result from degradation of mechanically-displaceable antenna panels. That is, as motors/actuators used to displace antenna panels degrade over time, a CPE may be configured to report such degraded capabilities so that the network can schedule the CPE to perform communications that may be performed by the CPE despite the degraded capabilities.

For instance, the wireless communications system 100 may include one or more CPEs that includes mechanically-displaceable antenna panels. Upon setup, the CPE may report that it can perform communications with a particular set of beams/TCI states. Subsequently, the CPE may identify a mechanical degradation that affects the ability of the CPE to move/actuate the antenna panels, which impacts the ability of the CPE to perform communications with some of the reported beams/TCI states. By reporting this mechanical degradation (and the impact to the communication capabilities of the CPE), the network can schedule communications at the CPE using the beams/TCI state that are still usable by the CPE.

Techniques described herein may enable wireless devices (e.g., CPEs, UEs 115) to report communications parameters/capabilities based on the performance of mechanically-displaceable antenna panels. In particular, as the mechanical-displacement capabilities of the mechanically-displaceable antenna panels degrade over time, aspects of the present disclosure may enable the UEs 115/CPEs to report corresponding communications parameters/capabilities resulting from the current status/capabilities of the mechanically-displaceable antenna panels. As such, techniques described herein may enable the network to tailor communications scheduled to be performed at the UEs 115/CPEs based on the current status/capabilities of the mechanically-displaceable antenna panels. Therefore, techniques described herein may result in more efficient and reliable wireless communications performed by devices with mechanically-displaceable antenna panels, thereby leading to less retransmissions, less network congestion, more efficient use of resources, and reduced power consumption at the UEs 115/CPEs.

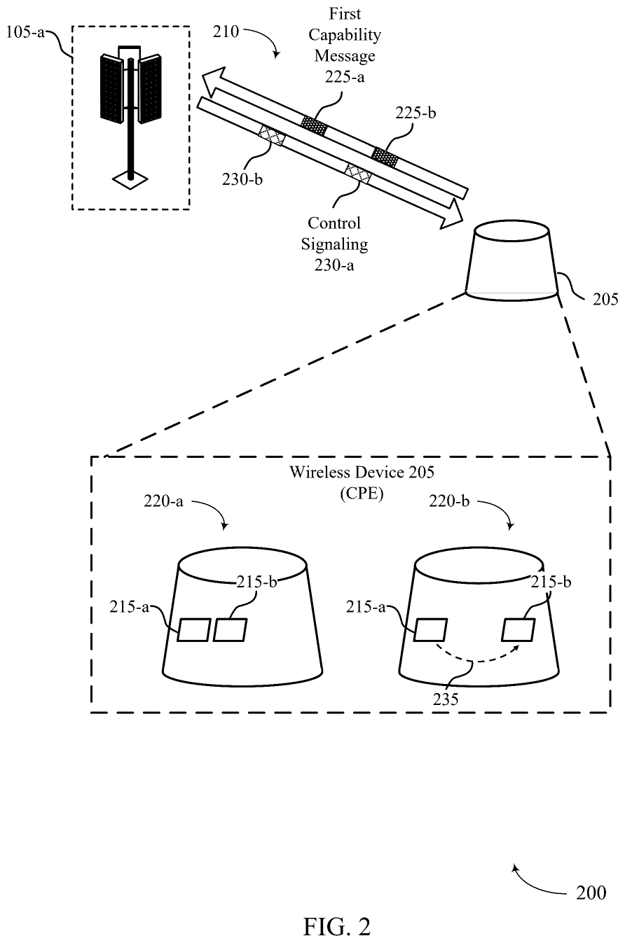

FIG. 2 shows an example of a wireless communications system 200 that supports techniques for mitigating motor failure for devices with mechanically displaceable antenna panels in accordance with one or more aspects of the present disclosure. In some examples, aspects of the wireless communications system 200 may implement, or be implemented by, aspects of the wireless communications system 100. In particular, the wireless communications system 200 illustrates signaling and configurations for reporting communications parameters/capabilities associated with mechanically-displaceable antenna panels.

The wireless communications system 200 may include a network entity 105-a and a wireless device 205, which may be examples of wireless devices as described herein. For example, the wireless device 205 may be an example of a UE 115, a CPE, and the like.

In some aspects, the network entity 105-a and the wireless device 205 may communicate with one another using a communication link 210, which may be an example of an NR or LTE link, a sidelink (e.g., PC5 link), and the like, between the respective devices. In some cases, the communication link 210 may include an example of an access link (e.g., Uu link) which may include a bi-directional link that enables both uplink and downlink communication. For example, the wireless device 205 may transmit uplink signals, such as uplink control signals or uplink data signals, to one or more components of the network entity 105-a using the communication link 210, and one or more components of the network entity 105-a may transmit downlink signals, such as downlink control signals or downlink data signals, to the wireless device 205 using the communication link 210.

In some aspects, the wireless device 205 may include one or more mechanically-displaceable antenna panels 215 that may be actuated or moved in order to facilitate wireless communications in various directions. In particular, the wireless device 205 may include one or more motors or actuators that are configured to physically move or actuate the mechanically-displaceable antenna panels 215 by discrete, known amounts. The actuation/displacement of the mechanically-displaceable antenna panels 215 may be linear (e.g., along, X, Y, and/or Z axes) and/or angular/radial (e.g., rotation from one location to another).

For example, as shown in FIG. 2, the wireless device 205 may include a first mechanically-displaceable antenna panel 215-a and a second mechanically-displaceable antenna panel 215-b. In this example, the mechanically-displaceable antenna panels 215 may be movable between a first configuration 220-a and a second configuration 220-b. For instance, the second mechanically-displaceable antenna panel 215-b may be moved (e.g., rotated) via a mechanical actuation 235 between the first configuration 220-a and the second configuration 220-b (e.g., via one or more motors/actuators). In this regard, the mechanically-displaceable antenna panels 215-a, 215-b may be co-located in the first configuration 220-a (such as for communications with a single node), where the mechanically-displaceable antenna panels 215-a, 215-b may be non-co-located in the second configuration 220-b (such as for communications with multiple nodes).

The use of mechanically-displaceable antenna panels 215 may enable the wireless device 205 to perform wireless communications in different directions, while simultaneously reducing the complexity and cost of the wireless device 205 relative to some other devices. For example, manufacturers of wireless devices (e.g., CPEs) may move from the use of large antenna arrays (e.g., 8×8, 16×8, and 16×16 antenna arrays) to smaller arrays for lower cost implementations in specific markets. In such cases, the use of a Cassegrain reflector or a mechanical rotator may allow better effective isotropic radiated power (EIRP)/increased array gain without the use of large antenna arrays. In this regard, the use of mechanically-displaceable antenna panels 215 may reduce power consumption and thermal overhead at the wireless device 205.

For instance, in the context of a reflector device, a smaller antenna array may be used, where a reflector may be rotated around the antenna array to transmit/receive wireless signals in a particular direction. In such cases, the antenna array and corresponding reflector may collectively be referred to as a mechanically-displaceable antenna panel 215.

Thus, the use of mechanically-displaceable antenna panels 215 may offer several advantages, including reduced cost and lower complexity. However, because the mechanically-displaceable antenna panels 215 rely on motors or actuators to physically move portions of the mechanically-displaceable antenna panels 215, these wireless devices 205 may be susceptible to mechanical degradation, which may detrimentally impact the ability of the wireless device 205 to perform wireless communications over time. That is, given the use of a mechanical motor to control the rotators/reflectors of the mechanically-displaceable antenna panels 215 in low-cost CPE implementations, motor failures or deterioration over time may affect the ability of the wireless device 205 to move the mechanically-displaceable antenna panels 215, and therefore affect the ability of the wireless device 205 to perform wireless communications. These motor failures could lead to far-reaching changes in the physical layer performance of the CPE with time.

Mechanical motors/actuators can fail due to a number of reasons. For example, mechanical motor failures may result from power supply imbalances (e.g., transient voltages, imbalanced voltages, harmonic distortions, etc.). Some wireless devices 205 may include protections to handle such imbalances, but these protections can fail due to the low-cost nature of the wireless devices 205. Further, mechanical failures/degradation may result from mechanical misalignments within the motor/actuator. For instance, angular misalignments may occur when shaft centerlines of the motor/actuator and other components intersect, but are not parallel with one another. Comparatively, parallel misalignment may occur when shaft centerlines of the motor/actuator and other components are parallel with one another, but do not intersect.

When a motor/actuator associated with the mechanically-displaceable antenna panels 215 fails, there may be many impacts from the antenna panel alignment perspective. For example, the failed/degraded motor may produce reduced speed/torque for actuating/displacing the mechanically-displaceable antenna panels 215, and thus lead to an increased time to displace the mechanically-displaceable antenna panels 215 by the same distance. Similarly, the motor may perform displacement with a reduced angular/distance range, leading to a reduced scan angle for the mechanically-displaceable antenna panels 215. Further, the failed/degraded motor may consume more power when actuating the mechanically-displaceable antenna panels 215 (thereby producing more thermal energy, which may raise the temperature of the wireless device 205 and impact wireless performance). Additionally, at a high level, as the motor wears over time, the motor may perform irregularly in contrast to expected/indicated displacement trajectories.

For example, as the motors/actuators experience wear over time, the linear and/or angular displacement range over which the mechanically-displaceable antenna panels 215 can be moved may decrease, which may reduce the beamforming capabilities of the wireless device 205, and decrease the angular range over which the wireless device 205 can transmit/receive communications. Taken together, the degradation of the mechanical-displacement capabilities of the antenna panels may detrimentally affect the ability of the wireless device 205 to perform wireless communications.

Accordingly, aspects of the present disclosure are directed to feedback mechanisms used to indicate dynamic capability quantities to a network entity that reflect CPE's motor behavior as the life-history of the device increases. In other words, aspects of the present disclosure are directed to signaling mechanisms that enable the wireless device 205 to report communications capabilities/parameters associated with the mechanically-displaceable antenna panels 215. In this regard, as the motors/actuators associated with the mechanically-displaceable antenna panels 215 degrade over time, aspects of the present disclosure may be used to indicate changing communications capabilities/parameters to the network entity 105-a, thereby enabling the network entity 105-a to schedule communications at the wireless device 205 based on the changing communications capabilities/parameters.

For example, referring to the wireless communications system 200 illustrated in FIG. 2, the wireless device 205 may transmit, to the network entity 105-a, a first capability message 225-a indicating a first set of communication parameters associated with the one or more mechanically-displaceable antenna panels 215 of the wireless device 205. For instance, at start-up, and/or upon being connected to the network, a CPE may indicate a capability field (e.g., via the first capability message 225-a) that indicates the CPE includes mechanically-displaceable antenna panels 215 that are controlled by motors. In such cases, at start-up (and/or upon connecting to the network), the CPE may indicate communication parameters/capabilities associated with the mechanically-displaceable antenna panels 215.

The first set of communication parameters may include, but are not limited to, a range of scan angles of the mechanically-displaceable antenna panels 215, a linear displacement range of the mechanically-displaceable antenna panels 215, a displacement duration for actuating the mechanically-displaceable antenna panels 215 (e.g., how long it takes to move/actuate the panels a certain distance/range), a power consumption associated with the mechanically-displaceable antenna panels 215, a beamforming capability of the mechanically-displaceable antenna panels 215, or any combination thereof. By way of another example, the first set of communication parameters may include a coherent beamforming capability of the mechanically-displaceable antenna panels 215, beamforming gains associated with the mechanically-displaceable antenna panels 215, or both.

In some aspects, the wireless device 205 may receive, from the network entity 105-a, control signaling 230-a (e.g., DCI message(s), RRC message(s), MAC-CE message(s)) that indicates information for communicating with the network entity 105-a, where the information may be based on the first set of communication parameters indicated via the first capability message 225-a.

For example, the control signaling 230-a may indicate a set of TCI states and/or a beamforming codebook for communications between the network entity 105-a and the wireless device 205, where the indicated TCI states are based on beamforming capabilities associated with the mechanically-displaceable antenna panels 215. By way of another example, the control signaling 230-a may schedule wireless communications to be performed by the wireless device 205, where a time duration between the scheduled communications is based on the displacement duration for actuating the mechanically-displaceable antenna panels 215 (e.g., how long it takes to move/actuate the panels a certain distance/range).

Subsequently, the wireless device 205 and the network entity 105-a may communicate with one another during a first time interval. In particular, the wireless device 205 and the network entity 105-a may communicate with one another in accordance with the first set of communication parameters indicated via the first capability message 225-a, and in accordance with the information indicated via the control signaling 230-a. For instance, the wireless device 205 may communicate (e.g., transmit and/or receive signals/messages) in accordance with the TCI state(s) and/or beamforming codebook indicated via the control signaling 230-a.

In some cases, the wireless device 205 may identify a change within the first set of communication parameters associated with the mechanically-displaceable antenna panels 215. In some aspects, the change in the first set of communication parameters (e.g., to a second set of communication parameters) may be based on or otherwise attributable to a mechanical degradation of the mechanically-displaceable antenna panels 215 (e.g., a degradation/failure of a motor/actuator used to displace the mechanically-displaceable antenna panels 215).

In some aspects, a change in the first set of communication parameters (e.g., to a second set of communication parameters) may refer to a change of a value of a communication parameter (e.g., a change of an angular and/or linear displacement range of the mechanically-displaceable antenna panels 215, a change of a displacement duration for actuating/displacing the mechanically-displaceable antenna panels 215, etc.). For example, the wireless device 205 may identify that an angular and/or linear displacement range of the mechanically-displaceable antenna panels 215 has decreased. By way of another example, the wireless device 205 may identify that a displacement duration for actuating/displacing the mechanically-displaceable antenna panels 215 has increased (e.g., it takes longer to displace the mechanically-displaceable antenna panels 215). In other cases, the wireless device 205 may identify that displacement of the mechanically-displaceable antenna panels 215 results in higher power consumption and/or thermal energy generation.

The wireless device 205 may transmit, to the network entity 105-a, a second capability message 225-b indicating a second set of communication parameters associated with the one or more mechanically-displaceable antenna panels 215 of the wireless device 205. That is, the wireless device 205 may indicate the second set (e.g., “new” set) of communication parameters. In this regard, as the performance of the motor used to move the mechanically-displaceable antenna panels 215 deteriorates over time, the CPE can dynamically update the communication parameters/capabilities associated with the mechanically-displaceable antenna panels 215.

In particular, the wireless device 205 may transmit the second capability message 225-b based on identifying that a change in at least one communication parameter of the first set of communication parameters satisfies some deviation threshold. That is, changes in communication parameters which satisfy some deviation threshold may be used as a trigger condition for reporting new/updated communication parameters associated with the mechanically-displaceable antenna panels 215.

In particular, the wireless device 205 may transmit the second capability message 225-b indicating the second set of communication parameters when at least one parameter of the second set of communication parameter is degraded relative to the first set of communication parameters. For the purposes of the present disclosure, a communication parameter may be said to be “degraded” when the new value of the communication parameter may result in lower performance (relative to performance of the first set of communication parameters). For instance, a higher power consumption associated with the second set of communication parameters relative to the first set of communication parameters may be considered a degradation of a communication parameter associated with power consumption at the wireless device 205. By way of another example, a reduction in the linear/angular range over which the mechanically-displaceable antenna panels 215 are able to be moved may be considered a degradation of a communication parameter associated with the a linear/angular displacement range of the mechanically-displaceable antenna panels 215.

As noted previously herein, the second set of communication parameters may include, but are not limited to, a range of scan angles of the mechanically-displaceable antenna panels 215, a linear displacement range of the mechanically-displaceable antenna panels 215, a displacement duration for actuating the mechanically-displaceable antenna panels 215 (e.g., how long it takes to move/actuate the panels a certain distance/range), a power consumption associated with the mechanically-displaceable antenna panels 215, a beamforming capability of the mechanically-displaceable antenna panels 215, or any combination thereof.

By way of another example, in cases where the linear/angular displacement range of the mechanically-displaceable antenna panels 215 has decreased, the wireless device 205 (e.g., CPE) may indicate a measure of reduced coherent beamforming gains that are achievable/possible when two mechanically-displaceable antenna panels 215 are coherently combined. In some cases, the indication can be binary (e.g., indicate whether or not coherent beamforming gains are useful at CPE). In other cases, the wireless device 205 may indicate when coherent combining is possible within a certain displacement range, and/or how much coherent beamforming is possible (e.g., with pre-loaded beamforming codebooks used for combining of panels). In other cases, the wireless device 205 may indicate a request or requirement for network assistance to determine adaptive/dynamic beam weights needed for coherent combining (followed by reference signal assistance).

In this regard, the wireless device 205 may transmit reports/capability messages 225 to dynamically update communication parameters/capabilities associated with the mechanically-displaceable antenna panels 215. That is, a CPE may indicate (to the network entity 105-a) a dynamic capability field that corresponds to deterioration/degradation in motor performance associated with the mechanically-displaceable antenna panels 215. For instance, the second capability message 225 may include a detailed report on the deterioration in performance of various communication parameters, such as: limited scan angle or displacements (e.g., how much relative angular displacement can be seen for each of the mechanically-displaceable antenna panels 215 relative to a fixed panel or some defined configuration/orientation), longer times for displacing the panels to the same angular settings (e.g., exact time/quantized version of the time taken for displacement to different angle ranges), increased power consumption/associated thermal levels (e.g., how much relative increase in power is seen).

Subsequently, the wireless device 205 may receive, from the network entity 105-a, additional control signaling 230-b (e.g., DCI message(s), RRC message(s), MAC-CE message(s)) that indicates additional information for communicating with the network entity 105-a, where the additional information may be based on the second set of communication parameters indicated via the second capability message 225-b.

Stated differently, based on the second capability message 225-b/report from the CPE, the network entity 105-a can prepare the network for degraded CPE performance due to motor failure. For example, in the case of limited scan angles, given a stationary environment, the network entity 105-a can cancel/degrade some TCI states for communications with the wireless device 205/CPE since such beam choices may not be exercised at the CPE. In some cases, these changes may be implemented slowly, as the coherence time of a channel between the network entity 105-a and a CPE may be much longer than that of a channel between the network entity 105-a and a UE 115. By way of another example, in the case of longer times for mechanical displacement, the network entity 105-a can use a longer wait period (e.g., fallow time) for CPE displacement to settle down before beginning communications. In other words, in cases where the second capability message 225-b indicates that it is taking longer to move/displace the mechanically-displaceable antenna panels 215, the additional control signaling 230-b may separate scheduled communications further in the time domain to enable the wireless device 205 sufficient time to move the mechanically-displaceable antenna panels 215. By way of yet another example, if the wireless device 205/CPE is operating under network energy savings (NES and/or reduced power consumption modes (and/or if the wireless device 205 indicates displacement of the mechanically-displaceable antenna panels 215 is consuming more energy than before), the network entity 105-a can limit how much displacement is performed at the CPE (e.g., by scheduling communications that require little or no displacement of the mechanically-displaceable antenna panels 215).

Subsequently, the wireless device 205 and the network entity 105-a may communicate with one another during a second time interval. In particular, the wireless device 205 and the network entity 105-a may communicate with one another in accordance with the second set of communication parameters indicated via the second capability message 225-b, and in accordance with the additional information indicated via the additional control signaling 230-b.

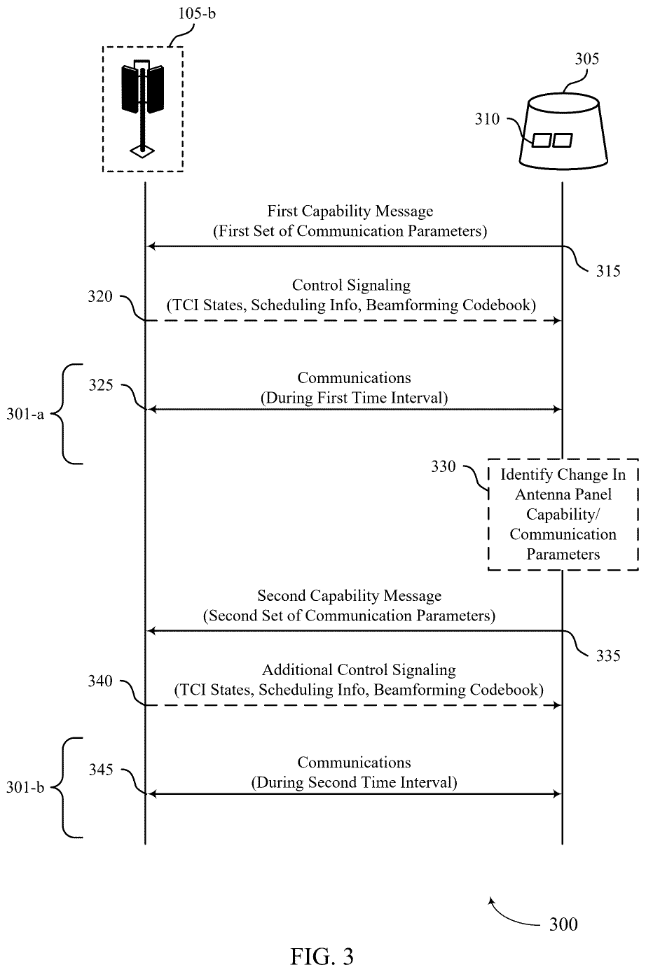

FIG. 3 shows an example of a process flow 300 that supports techniques for mitigating motor failure for devices with mechanically displaceable antenna panels in accordance with one or more aspects of the present disclosure. In some examples, aspects of the process flow 300 may implement, or be implemented by, aspects of the wireless communications system 100, the wireless communications system 200, or both. In particular, the process flow 300 illustrates signaling and configurations for reporting communications parameters/capabilities associated with mechanically-displaceable antenna panels.

The process flow 300 includes a network entity 105-b and a wireless device 305, which may be examples of wireless devices as described herein. For example, the wireless device 305 illustrated in FIG. 3 may include an example of the wireless device 205 illustrated in FIG. 2, and may include a CPE, a UE 115, and the like. In this regard, the wireless device 305 may include one or more mechanically-displaceable antenna panels 310 that may be actuated (e.g., linearly, angularly/radially) to facilitate wireless communications.

In some examples, the operations illustrated in process flow 300 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At signaling operation 315, the wireless device 305 may transmit, to the network entity 105-b, a first capability message indicating a first set of communication parameters associated with the one or more mechanically-displaceable antenna panels 310 of the wireless device 305.

The first set of communication parameters may include, but are not limited to, a range of scan angles of the mechanically-displaceable antenna panels 310, a linear displacement range of the mechanically-displaceable antenna panels 310, a displacement duration for actuating the mechanically-displaceable antenna panels 310 (e.g., how long it takes to move/actuate the panels a certain distance/range), a power consumption associated with the mechanically-displaceable antenna panels 310, a beamforming capability of the mechanically-displaceable antenna panels 310, or any combination thereof. By way of another example, the first set of communication parameters may include a coherent beamforming capability of the mechanically-displaceable antenna panels 310, beamforming gains associated with the mechanically-displaceable antenna panels 310, or both.

At signaling operation 320, the wireless device 305 may receive, from the network entity 105-b, control signaling (e.g., DCI message(s), RRC message(s), MAC-CE message(s)) that indicates information for communicating with the network entity 105-b. The information may be based on the first set of communication parameters indicated via the first capability message at signaling operation 315.

For example, the control signaling may indicate a set of TCI states and/or a beamforming codebook for communications between the network entity 105-b and the wireless device 305, where the indicated TCI states are based on beamforming capabilities associated with the mechanically-displaceable antenna panels 310. By way of another example, the control signaling may schedule wireless communications to be performed by the wireless device 305, where a time duration between the scheduled communications is based on the displacement duration for actuating the mechanically-displaceable antenna panels 310 (e.g., how long it takes to move/actuate the panels a certain distance/range).

At signaling operation 325, the wireless device 305 and the network entity 105-b may communicate with one another during a first time interval 301-a. In particular, the wireless device 305 and the network entity 105-b may communicate with one another in accordance with the first set of communication parameters indicated via the first capability message at signaling operation 315, and in accordance with the information indicated via the control signaling at signaling operation 320.

For instance, the wireless device 305 may communicate in accordance with the TCI state(s) and/or beamforming codebook indicated via the control signaling at signaling operation 320.

At operation 330, the wireless device 305 may identify a change within the first set of communication parameters associated with the mechanically-displaceable antenna panels 310. In some aspects, the change in the first set of communication parameters (e.g., to a second set of communication parameters) may be based on or otherwise attributable to a mechanical degradation of the mechanically-displaceable antenna panels 310 (e.g., a degradation/failure of a motor/actuator used to displace the mechanically-displaceable antenna panels 310).

For example, the wireless device 305 may identify that an angular and/or linear displacement range of the mechanically-displaceable antenna panels 310 has decreased. By way of another example, the wireless device 305 may identify that a displacement duration for actuating/displacing the mechanically-displaceable antenna panels 310 has increased (e.g., it takes longer to displace the mechanically-displaceable antenna panels 310). In other cases, the wireless device 305 may identify that displacement of the mechanically-displaceable antenna panels 310 results in higher power consumption and/or thermal energy generation.

At signaling operation 335, the wireless device 305 may transmit, to the network entity 105-b, a second capability message indicating a second set of communication parameters associated with the one or more mechanically-displaceable antenna panels 310 of the wireless device 305. That is, the wireless device 305 may indicate the second set (e.g., “new” set) of communication parameters which were identified at operation 330. In particular, the wireless device 305 may transmit the second capability message based on identifying that a change in at least one communication parameter of the first set of communication parameters satisfies some deviation threshold. That is, changes in communication parameters which satisfy some deviation threshold may be used as a trigger condition for reporting new/updated communication parameters associated with the mechanically-displaceable antenna panels 310.

As noted previously herein, the second set of communication parameters may include, but are not limited to, a range of scan angles of the mechanically-displaceable antenna panels 310, a linear displacement range of the mechanically-displaceable antenna panels 310, a displacement duration for actuating the mechanically-displaceable antenna panels 310 (e.g., how long it takes to move/actuate the panels a certain distance/range), a power consumption associated with the mechanically-displaceable antenna panels 310, a beamforming capability of the mechanically-displaceable antenna panels 310, or any combination thereof. By way of another example, the second set of communication parameters may include a coherent beamforming capability of the mechanically-displaceable antenna panels 310, beamforming gains associated with the mechanically-displaceable antenna panels 310, or both.

At signaling operation 340, the wireless device 305 may receive, from the network entity 105-b, additional control signaling (e.g., DCI message(s), RRC message(s), MAC-CE message(s)) that indicates additional information for communicating with the network entity 105-b, where the additional information may be based on the second set of communication parameters indicated via the second capability message at signaling operation 335.

For example, in cases where the second capability message indicates degraded beamforming capabilities associated with the mechanically-displaceable antenna panels 310, the second control signaling may indicate a second set of TCI states (e.g., “modified” set of TCI states) and/or a second beamforming codebook (e.g., “modified” beamforming codebook) for communications between the network entity 105-b and the wireless device 305 (where the TCI states/beamforming codebook are modified relative to the TCI states/beamforming codebook indicated via the control signaling at signaling operation 320 based on the second capability message). In such cases, the “second set of TCI states” or “modified set of TCI states” may be said to be “modified” when at least one TCI state from the second/modified set of TCI states is removed or changed relative to the set of TCI states indicated via the signaling operation 320, and/or when a new TCI state is added to the second/modified set of TCI states relative to the set of TCI states indicated via the signaling operation 320. Similarly, the “second beamforming codebook” or “modified beamforming codebook” may be said to be “modified” when at least one beam/beamforming configuration from the second/modified beamforming configuration is removed or changed relative to the beamforming codebook indicated via the signaling operation 320, and/or when a new beam/beamforming configuration is added to the second/modified beamforming codebook relative to the beamforming codebook indicated via the signaling operation 320.

By way of another example, in cases where the second capability message indicates that it is taking longer to move/displace the mechanically-displaceable antenna panels 310, the additional control signaling may separate scheduled communications further in the time domain to enable the wireless device 305 sufficient time to move the mechanically-displaceable antenna panels 310.

At signaling operation 345, the wireless device 305 and the network entity 105-b may communicate with one another during a second time interval 301-b. In particular, the wireless device 305 and the network entity 105-b may communicate with one another in accordance with the second set of communication parameters indicated via the second capability message at signaling operation 335, and in accordance with the additional information indicated via the additional control signaling at signaling operation 340.

In some implementations, due to the degradation of at least one communication parameter of the second set of communication parameters (relative to the first set of communication parameters), the movement of the mechanically-displaceable antenna panels 310 during the second time interval 301-a may be associated with a higher power consumption as compared to the movement of the mechanically-displaceable antenna panels 310 during the first time interval. Stated differently, due to the degradation of the motors and/or actuators of the mechanically-displaceable antenna panels 310, a displacement of the mechanically-displaceable antenna panels 310 during the second time interval 301-b may result in a higher power consumption as compared to the same displacement performed during the first time interval 301-a. As such, in order to reduce the power consumption of the wireless device 305 during the second time interval 301-b, the network entity 105-b may schedule communications during the second time interval 301-b in such a manner as to minimize (or otherwise limit or reduce) the quantity of mechanical displacements of the mechanically-displaceable antenna panels 310. In this regard, the wireless device 305 may be required/expected to perform fewer mechanical displacements (and/or displacements with smaller magnitudes) of the mechanically-displaceable antenna panels 310 during the second time interval 301-b as compared to the first time interval 301-a.

Further, due to the degradation of at least one communication parameter of the second set of communication parameters (relative to the first set of communication parameters), the it may take longer to move or displace the mechanically-displaceable antenna panels 310 during the second time interval 301-a as compared to the first time interval 301-a (e.g., shorter displacement durations during the first time interval 301-a, and longer displacement durations during the second time interval 301-b). As such, the network entity 105-b may schedule communications during the second time interval 301-b in order to accommodate for the longer displacement durations expected during the second time interval 301-b (e.g., by providing more time between scheduled communications that require a displacement of the mechanically-displaceable antenna panels 310).

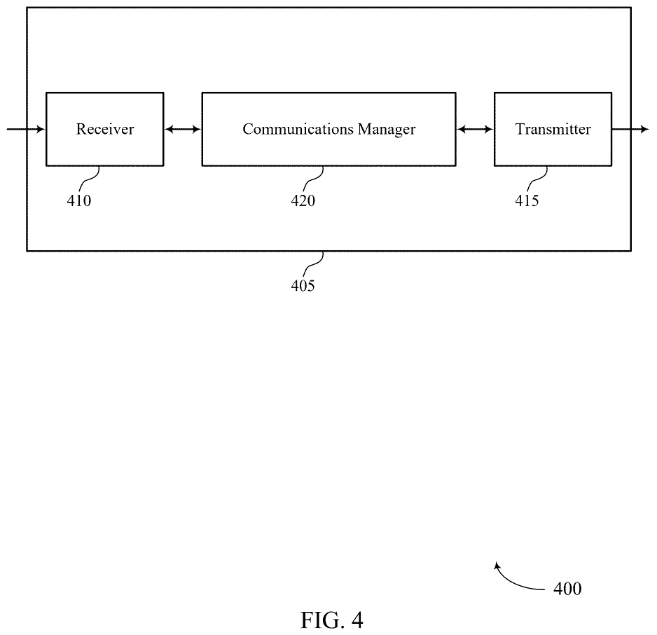

FIG. 4 shows a block diagram 400 of a device 405 that supports techniques for mitigating motor failure for devices with mechanically displaceable antenna panels in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to techniques for mitigating motor failure for devices with mechanically displaceable antenna panels). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to techniques for mitigating motor failure for devices with mechanically displaceable antenna panels). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of techniques for mitigating motor failure for devices with mechanically displaceable antenna panels as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

For example, the communications manager 420 is capable of, configured to, or operable to support a means for transmitting, to a second wireless device, a first capability message indicating a first set of communication parameters associated with one or more mechanically-displaceable antenna panels of the first wireless device. The communications manager 420 is capable of, configured to, or operable to support a means for communicating, during a first time interval, with the second wireless device using the one or more mechanically-displaceable antenna panels and in accordance with the first set of communication parameters. The communications manager 420 is capable of, configured to, or operable to support a means for transmitting, to the second wireless device, a second capability message indicating a second set of communication parameters associated with one or more mechanically-displaceable antenna panels, where at least one communication parameter of the second set of communication parameters is degraded relative to the first set of communication parameters based on a mechanical degradation of the one or more mechanically-displaceable antenna panels. The communications manager 420 is capable of, configured to, or operable to support a means for communicating, during a second time interval, with the second wireless device using the one or more mechanically-displaceable antenna panels and in accordance with the second set of communication parameters.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques that enable wireless devices (e.g., CPEs, UEs 115) to report communications parameters/capabilities based on the performance of mechanically-displaceable antenna panels. In particular, as the mechanical-displacement capabilities of the mechanically-displaceable antenna panels degrade over time, aspects of the present disclosure may enable the UEs 115/CPEs to report corresponding communications parameters/capabilities resulting from the current status/capabilities of the mechanically-displaceable antenna panels. As such, techniques described herein may enable the network to tailor communications scheduled to be performed at the UEs 115/CPEs based on the current status/capabilities of the mechanically-displaceable antenna panels. Therefore, techniques described herein may result in more efficient and reliable wireless communications performed by devices with mechanically-displaceable antenna panels, thereby leading to less retransmissions, less network congestion, more efficient use of resources, and reduced power consumption at the UEs 115/CPEs.

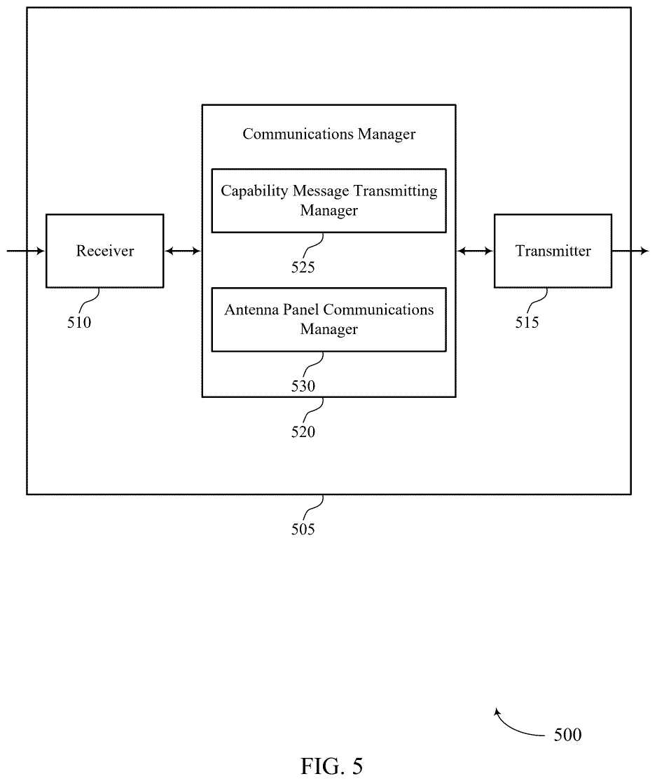

FIG. 5 shows a block diagram 500 of a device 505 that supports techniques for mitigating motor failure for devices with mechanically displaceable antenna panels in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for mitigating motor failure for devices with mechanically displaceable antenna panels). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for mitigating motor failure for devices with mechanically displaceable antenna panels). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of techniques for mitigating motor failure for devices with mechanically displaceable antenna panels as described herein. For example, the communications manager 520 may include a capability message transmitting manager 525 an antenna panel communications manager 530, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The capability message transmitting manager 525 is capable of, configured to, or operable to support a means for transmitting, to a second wireless device, a first capability message indicating a first set of communication parameters associated with one or more mechanically-displaceable antenna panels of the first wireless device. The antenna panel communications manager 530 is capable of, configured to, or operable to support a means for communicating, during a first time interval, with the second wireless device using the one or more mechanically-displaceable antenna panels and in accordance with the first set of communication parameters. The capability message transmitting manager 525 is capable of, configured to, or operable to support a means for transmitting, to the second wireless device, a second capability message indicating a second set of communication parameters associated with one or more mechanically-displaceable antenna panels, where at least one communication parameter of the second set of communication parameters is degraded relative to the first set of communication parameters based on a mechanical degradation of the one or more mechanically-displaceable antenna panels. The antenna panel communications manager 530 is capable of, configured to, or operable to support a means for communicating, during a second time interval, with the second wireless device using the one or more mechanically-displaceable antenna panels and in accordance with the second set of communication parameters.

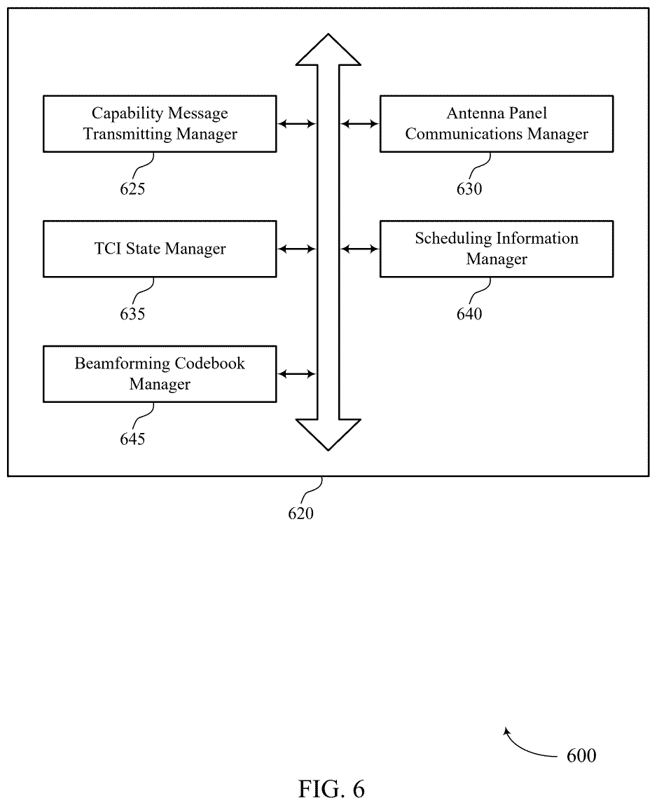

FIG. 6 shows a block diagram 600 of a communications manager 620 that supports techniques for mitigating motor failure for devices with mechanically displaceable antenna panels in accordance with one or more aspects of the present disclosure. The communications manager 620 may be an example of aspects of a communications manager 420, a communications manager 520, or both, as described herein. The communications manager 620, or various components thereof, may be an example of means for performing various aspects of techniques for mitigating motor failure for devices with mechanically displaceable antenna panels as described herein. For example, the communications manager 620 may include a capability message transmitting manager 625, an antenna panel communications manager 630, a TCI state manager 635, a scheduling information manager 640, a beamforming codebook manager 645, or any combination thereof. Each of these components, or components or subcomponents thereof (e.g., one or more processors, one or more memories), may communicate, directly or indirectly, with one another (e.g., via one or more buses).

The capability message transmitting manager 625 is capable of, configured to, or operable to support a means for transmitting, to a second wireless device, a first capability message indicating a first set of communication parameters associated with one or more mechanically-displaceable antenna panels of the first wireless device. The antenna panel communications manager 630 is capable of, configured to, or operable to support a means for communicating, during a first time interval, with the second wireless device using the one or more mechanically-displaceable antenna panels and in accordance with the first set of communication parameters. In some examples, the capability message transmitting manager 625 is capable of, configured to, or operable to support a means for transmitting, to the second wireless device, a second capability message indicating a second set of communication parameters associated with one or more mechanically-displaceable antenna panels, where at least one communication parameter of the second set of communication parameters is degraded relative to the first set of communication parameters based on a mechanical degradation of the one or more mechanically-displaceable antenna panels. In some examples, the antenna panel communications manager 630 is capable of, configured to, or operable to support a means for communicating, during a second time interval, with the second wireless device using the one or more mechanically-displaceable antenna panels and in accordance with the second set of communication parameters.

In some examples, the TCI state manager 635 is capable of, configured to, or operable to support a means for receiving, from the second wireless device in response to the second capability message, a control message indicating a modified set of TCI states, where communicating during the second time interval is performed in accordance with the modified set of TCI states.

In some examples, the second set of communication parameters includes a displacement duration for actuating the one or more mechanically-displaceable antenna panels, and the scheduling information manager 640 is capable of, configured to, or operable to support a means for receiving, from the second wireless device in response to the second capability message, control signaling including scheduling information for one or more communications to be performed by the first wireless device during the second time interval, where the scheduling information is based on the displacement duration for actuating the one or more mechanically-displaceable antenna panels.

In some examples, the one or more communications associated with the scheduling information include at least a first communication and a second communication. In some examples, a duration between the first communication and the second communication is based on the displacement duration for actuating the one or more mechanically-displaceable antenna panels.

In some examples, the first set of communication parameters and the second set of communication parameters include a first power consumption and a second power consumption associated with the one or more mechanically-displaceable antenna panels, respectively. In some examples, the second power consumption is greater than the first power consumption. In some examples, communicating during the first time interval is associated with a first quantity or magnitude of mechanical displacements of the one or more mechanically-displaceable antenna panels. In some examples, communicating during the second time interval is associated with a second quantity or magnitude of mechanical displacements of the one or more mechanically-displaceable antenna panels that is less than the first quantity or magnitude of mechanical displacements based on the second power consumption being greater than the first power consumption.

In some examples, the first set of communication parameters, the second set of communication parameters, or both, include a range of scan angles of the one or more mechanically-displaceable antenna panels, a linear displacement range of the one or more mechanically-displaceable antenna panels, a displacement duration for actuating the one or more mechanically-displaceable antenna panels, a power consumption associated with the one or more mechanically-displaceable antenna panels, a beamforming capability of the one or more mechanically-displaceable antenna panels, or any combination thereof.

In some examples, the beamforming codebook manager 645 is capable of, configured to, or operable to support a means for receiving, from the second wireless device in response to the second capability message, a control message indicating a modified beamforming codebook, where communicating during the second time interval is performed in accordance with the modified beamforming codebook.

In some examples, the second set of communication parameters includes a coherent beamforming capability of the one or more mechanically-displaceable antenna panels, one or more beamforming gains associated with the one or more mechanically-displaceable antenna panels, or both.

In some examples, the antenna panel communications manager 630 is capable of, configured to, or operable to support a means for identifying a change of the first set of communication parameters to the second set of communication parameters based on the mechanical degradation of the one or more mechanically-displaceable antenna panels, where transmitting the second capability message is based on identifying the change.

In some examples, the antenna panel communications manager 630 is capable of, configured to, or operable to support a means for identifying a change of a first communication parameter of the first set of communication parameters to a second communication parameter, the second communication parameter included within the second set of communication parameters, where transmitting the second capability message is based on the change satisfying a deviation threshold.

In some examples, the first wireless device includes a CPE, a UE, or both.

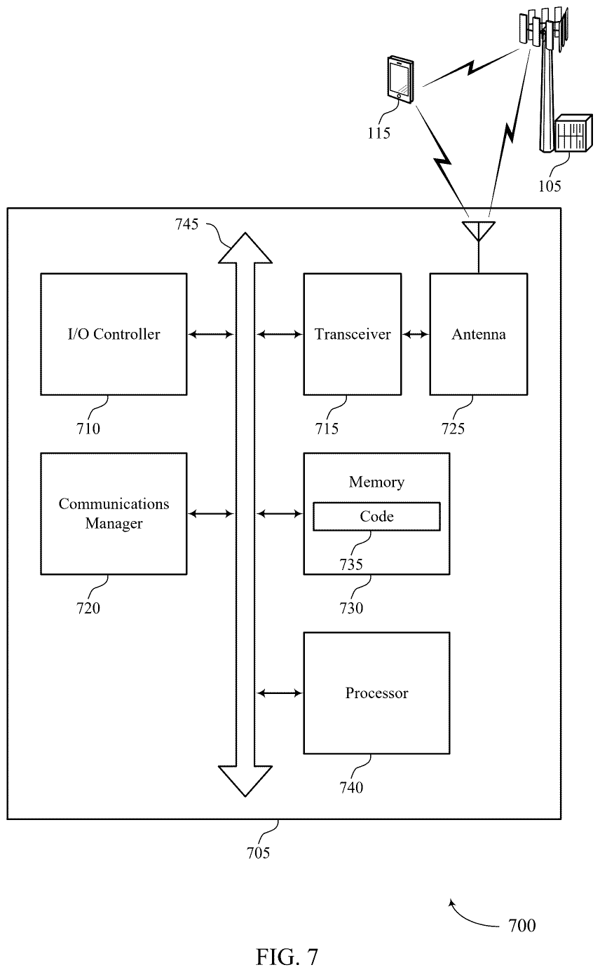

FIG. 7 shows a diagram of a system 700 including a device 705 that supports techniques for mitigating motor failure for devices with mechanically displaceable antenna panels in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting techniques for mitigating motor failure for devices with mechanically displaceable antenna panels). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

For example, the communications manager 720 is capable of, configured to, or operable to support a means for transmitting, to a second wireless device, a first capability message indicating a first set of communication parameters associated with one or more mechanically-displaceable antenna panels of the first wireless device. The communications manager 720 is capable of, configured to, or operable to support a means for communicating, during a first time interval, with the second wireless device using the one or more mechanically-displaceable antenna panels and in accordance with the first set of communication parameters. The communications manager 720 is capable of, configured to, or operable to support a means for transmitting, to the second wireless device, a second capability message indicating a second set of communication parameters associated with one or more mechanically-displaceable antenna panels, where at least one communication parameter of the second set of communication parameters is degraded relative to the first set of communication parameters based on a mechanical degradation of the one or more mechanically-displaceable antenna panels. The communications manager 720 is capable of, configured to, or operable to support a means for communicating, during a second time interval, with the second wireless device using the one or more mechanically-displaceable antenna panels and in accordance with the second set of communication parameters.

By including or configuring the communications manager 720 in accordance with examples as described herein, the device 705 may support techniques that enable wireless devices (e.g., CPEs, UEs 115) to report communications parameters/capabilities based on the performance of mechanically-displaceable antenna panels. In particular, as the mechanical-displacement capabilities of the mechanically-displaceable antenna panels degrade over time, aspects of the present disclosure may enable the UEs 115/CPEs to report corresponding communications parameters/capabilities resulting from the current status/capabilities of the mechanically-displaceable antenna panels. As such, techniques described herein may enable the network to tailor communications scheduled to be performed at the UEs 115/CPEs based on the current status/capabilities of the mechanically-displaceable antenna panels. Therefore, techniques described herein may result in more efficient and reliable wireless communications performed by devices with mechanically-displaceable antenna panels, thereby leading to less retransmissions, less network congestion, more efficient use of resources, and reduced power consumption at the UEs 115/CPEs.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of techniques for mitigating motor failure for devices with mechanically displaceable antenna panels as described herein, or the at least one processor 740 and the at least one memory 730 may be otherwise configured to, individually or collectively, perform or support such operations.

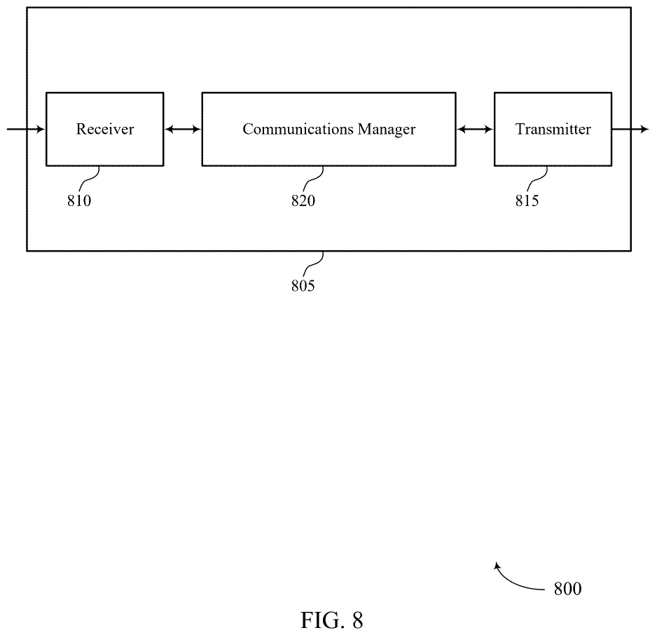

FIG. 8 shows a block diagram 800 of a device 805 that supports techniques for mitigating motor failure for devices with mechanically displaceable antenna panels in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of techniques for mitigating motor failure for devices with mechanically displaceable antenna panels as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

For example, the communications manager 820 is capable of, configured to, or operable to support a means for receiving, from a first wireless device, a first capability message indicating a first set of communication parameters associated with one or more mechanically-displaceable antenna panels of the first wireless device. The communications manager 820 is capable of, configured to, or operable to support a means for communicating, during a first time interval, with the first wireless device in accordance with the first set of communication parameters. The communications manager 820 is capable of, configured to, or operable to support a means for receiving, from the first wireless device, a second capability message indicating a second set of communication parameters associated with one or more mechanically-displaceable antenna panels, where at least one communication parameter of the second set of communication parameters is degraded relative to the first set of communication parameters based on a mechanical degradation of the one or more mechanically-displaceable antenna panels. The communications manager 820 is capable of, configured to, or operable to support a means for communicating, during a second time interval, with the first wireless device in accordance with the second set of communication parameters.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques that enable wireless devices (e.g., CPEs, UEs 115) to report communications parameters/capabilities based on the performance of mechanically-displaceable antenna panels. In particular, as the mechanical-displacement capabilities of the mechanically-displaceable antenna panels degrade over time, aspects of the present disclosure may enable the UEs 115/CPEs to report corresponding communications parameters/capabilities resulting from the current status/capabilities of the mechanically-displaceable antenna panels. As such, techniques described herein may enable the network to tailor communications scheduled to be performed at the UEs 115/CPEs based on the current status/capabilities of the mechanically-displaceable antenna panels. Therefore, techniques described herein may result in more efficient and reliable wireless communications performed by devices with mechanically-displaceable antenna panels, thereby leading to less retransmissions, less network congestion, more efficient use of resources, and reduced power consumption at the UEs 115/CPEs.

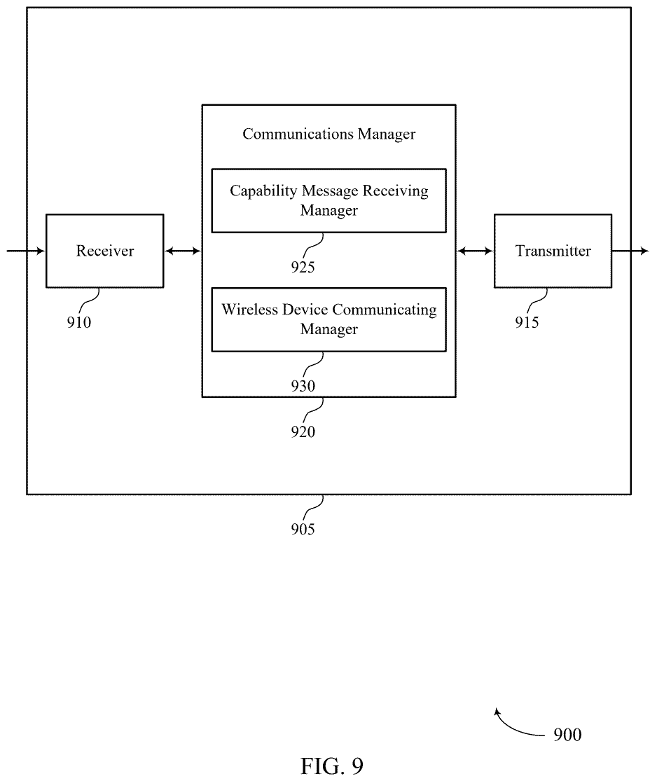

FIG. 9 shows a block diagram 900 of a device 905 that supports techniques for mitigating motor failure for devices with mechanically displaceable antenna panels in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of techniques for mitigating motor failure for devices with mechanically displaceable antenna panels as described herein. For example, the communications manager 920 may include a capability message receiving manager 925 a wireless device communicating manager 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The capability message receiving manager 925 is capable of, configured to, or operable to support a means for receiving, from a first wireless device, a first capability message indicating a first set of communication parameters associated with one or more mechanically-displaceable antenna panels of the first wireless device. The wireless device communicating manager 930 is capable of, configured to, or operable to support a means for communicating, during a first time interval, with the first wireless device in accordance with the first set of communication parameters. The capability message receiving manager 925 is capable of, configured to, or operable to support a means for receiving, from the first wireless device, a second capability message indicating a second set of communication parameters associated with one or more mechanically-displaceable antenna panels, where at least one communication parameter of the second set of communication parameters is degraded relative to the first set of communication parameters based on a mechanical degradation of the one or more mechanically-displaceable antenna panels. The wireless device communicating manager 930 is capable of, configured to, or operable to support a means for communicating, during a second time interval, with the first wireless device in accordance with the second set of communication parameters.

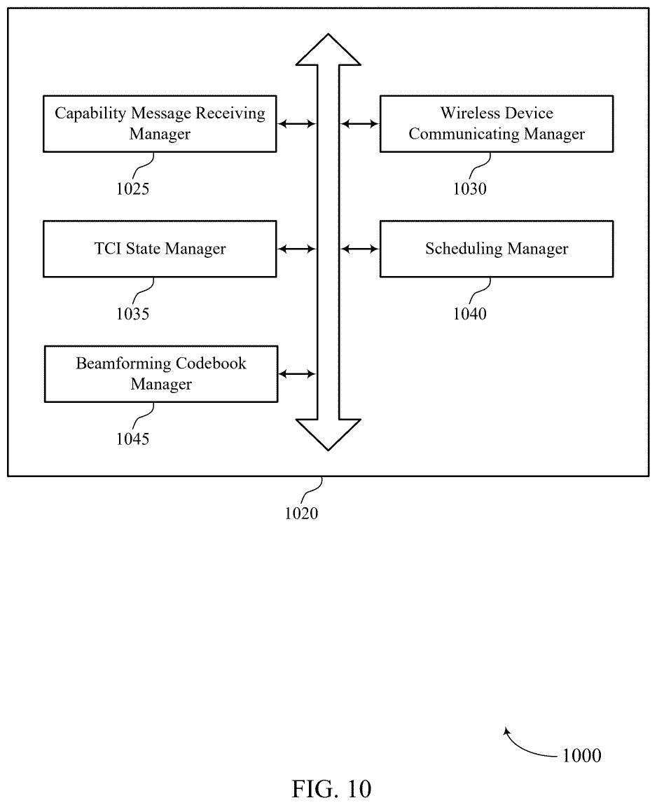

FIG. 10 shows a block diagram 1000 of a communications manager 1020 that supports techniques for mitigating motor failure for devices with mechanically displaceable antenna panels in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of techniques for mitigating motor failure for devices with mechanically displaceable antenna panels as described herein. For example, the communications manager 1020 may include a capability message receiving manager 1025, a wireless device communicating manager 1030, a TCI state manager 1035, a scheduling manager 1040, a beamforming codebook manager 1045, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The capability message receiving manager 1025 is capable of, configured to, or operable to support a means for receiving, from a first wireless device, a first capability message indicating a first set of communication parameters associated with one or more mechanically-displaceable antenna panels of the first wireless device. The wireless device communicating manager 1030 is capable of, configured to, or operable to support a means for communicating, during a first time interval, with the first wireless device in accordance with the first set of communication parameters. In some examples, the capability message receiving manager 1025 is capable of, configured to, or operable to support a means for receiving, from the first wireless device, a second capability message indicating a second set of communication parameters associated with one or more mechanically-displaceable antenna panels, where at least one communication parameter of the second set of communication parameters is degraded relative to the first set of communication parameters based on a mechanical degradation of the one or more mechanically-displaceable antenna panels. In some examples, the wireless device communicating manager 1030 is capable of, configured to, or operable to support a means for communicating, during a second time interval, with the first wireless device in accordance with the second set of communication parameters.

In some examples, the second set of communication parameters includes a displacement duration for actuating the one or more mechanically-displaceable antenna panels, and the scheduling manager 1040 is capable of, configured to, or operable to support a means for transmitting, to the first wireless device in response to the second capability message, control signaling including scheduling information for one or more communications to be performed by the first wireless device during the second time interval, where the scheduling information is based on the displacement duration for actuating the one or more mechanically-displaceable antenna panels.

In some examples, the one or more communications associated with the scheduling information include at least a first communication and a second communication. In some examples, a duration between the first communication and the second communication is based on the displacement duration for actuating the one or more mechanically-displaceable antenna panels.

In some examples, the first set of communication parameters and the second set of communication parameters include a first power consumption and a second power consumption associated with the one or more mechanically-displaceable antenna panels, respectively. In some examples, the second power consumption is greater than the first power consumption. In some examples, communicating during the first time interval is associated with a first quantity or magnitude of mechanical displacements of the one or more mechanically-displaceable antenna panels. In some examples, communicating during the second time interval is associated with a second quantity or magnitude of mechanical displacements of the one or more mechanically-displaceable antenna panels that is less than the first quantity or magnitude of mechanical displacements based on the second power consumption being greater than the first power consumption.

In some examples, the first set of communication parameters, the second set of communication parameters, or both, include a range of scan angles of the one or more mechanically-displaceable antenna panels, a linear displacement range of the one or more mechanically-displaceable antenna panels, a displacement duration for actuating the one or more mechanically-displaceable antenna panels, a power consumption associated with the one or more mechanically-displaceable antenna panels, a beamforming capability of the one or more mechanically-displaceable antenna panels, or any combination thereof.

In some examples, the second capability message indicates an inability of the first wireless device to communicate in accordance with at least a portion of the beamforming codebook, and the beamforming codebook manager 1045 is capable of, configured to, or operable to support a means for transmitting, to the first wireless device in response to the second capability message, a control message indicating a modified beamforming codebook, where communicating during the second time interval is performed in accordance with the modified beamforming codebook.

In some examples, the second set of communication parameters includes a coherent beamforming capability of the one or more mechanically-displaceable antenna panels, one or more beamforming gains associated with the one or more mechanically-displaceable antenna panels, or both.

In some examples, the first wireless device includes a CPE, a UE, or both.

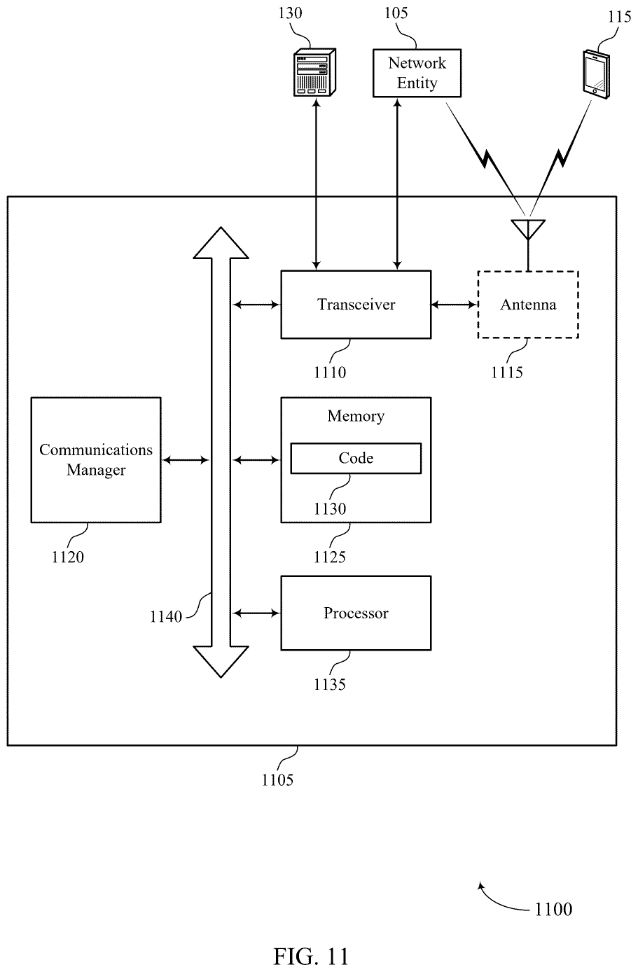

FIG. 11 shows a diagram of a system 1100 including a device 1105 that supports techniques for mitigating motor failure for devices with mechanically displaceable antenna panels in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting techniques for mitigating motor failure for devices with mechanically displaceable antenna panels). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

For example, the communications manager 1120 is capable of, configured to, or operable to support a means for receiving, from a first wireless device, a first capability message indicating a first set of communication parameters associated with one or more mechanically-displaceable antenna panels of the first wireless device. The communications manager 1120 is capable of, configured to, or operable to support a means for communicating, during a first time interval, with the first wireless device in accordance with the first set of communication parameters. The communications manager 1120 is capable of, configured to, or operable to support a means for receiving, from the first wireless device, a second capability message indicating a second set of communication parameters associated with one or more mechanically-displaceable antenna panels, where at least one communication parameter of the second set of communication parameters is degraded relative to the first set of communication parameters based on a mechanical degradation of the one or more mechanically-displaceable antenna panels. The communications manager 1120 is capable of, configured to, or operable to support a means for communicating, during a second time interval, with the first wireless device in accordance with the second set of communication parameters.

By including or configuring the communications manager 1120 in accordance with examples as described herein, the device 1105 may support techniques that enable wireless devices (e.g., CPEs, UEs 115) to report communications parameters/capabilities based on the performance of mechanically-displaceable antenna panels. In particular, as the mechanical-displacement capabilities of the mechanically-displaceable antenna panels degrade over time, aspects of the present disclosure may enable the UEs 115/CPEs to report corresponding communications parameters/capabilities resulting from the current status/capabilities of the mechanically-displaceable antenna panels. As such, techniques described herein may enable the network to tailor communications scheduled to be performed at the UEs 115/CPEs based on the current status/capabilities of the mechanically-displaceable antenna panels. Therefore, techniques described herein may result in more efficient and reliable wireless communications performed by devices with mechanically-displaceable antenna panels, thereby leading to less retransmissions, less network congestion, more efficient use of resources, and reduced power consumption at the UEs 115/CPEs.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of techniques for mitigating motor failure for devices with mechanically displaceable antenna panels as described herein, or the at least one processor 1135 and the at least one memory 1125 may be otherwise configured to, individually or collectively, perform or support such operations.

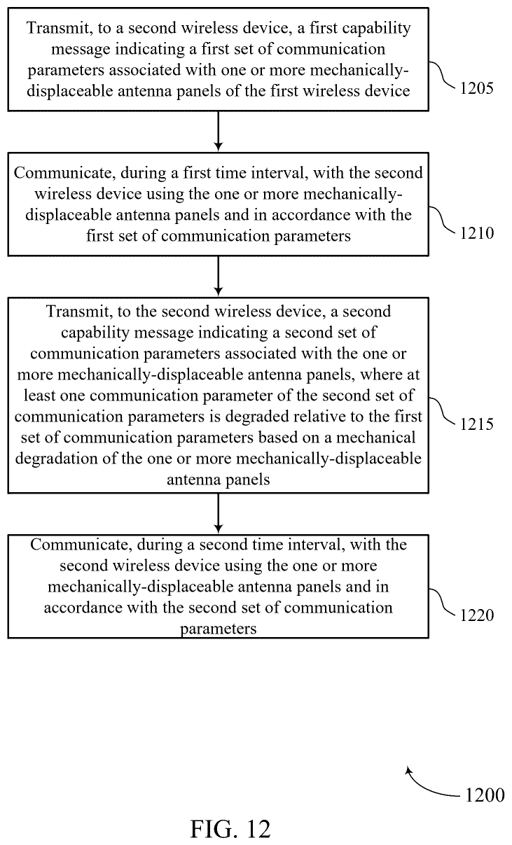

FIG. 12 shows a flowchart illustrating a method 1200 that supports techniques for mitigating motor failure for devices with mechanically displaceable antenna panels in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include transmitting, to a second wireless device, a first capability message indicating a first set of communication parameters associated with one or more mechanically-displaceable antenna panels of the first wireless device. The operations of 1205 may be performed in accordance with examples as disclosed herein. In some examples, aspects of the operations of 1205 may be performed by a capability message transmitting manager 625 as described with reference to FIG. 6.

At 1210, the method may include communicating, during a first time interval, with the second wireless device using the one or more mechanically-displaceable antenna panels and in accordance with the first set of communication parameters. The operations of 1210 may be performed in accordance with examples as disclosed herein. In some examples, aspects of the operations of 1210 may be performed by an antenna panel communications manager 630 as described with reference to FIG. 6.

At 1215, the method may include transmitting, to the second wireless device, a second capability message indicating a second set of communication parameters associated with the one or more mechanically-displaceable antenna panels, where at least one communication parameter of the second set of communication parameters is degraded relative to the first set of communication parameters based on a mechanical degradation of the one or more mechanically-displaceable antenna panels. The operations of 1215 may be performed in accordance with examples as disclosed herein. In some examples, aspects of the operations of 1215 may be performed by a capability message transmitting manager 625 as described with reference to FIG. 6.

At 1220, the method may include communicating, during a second time interval, with the second wireless device using the one or more mechanically-displaceable antenna panels and in accordance with the second set of communication parameters. The operations of 1220 may be performed in accordance with examples as disclosed herein. In some examples, aspects of the operations of 1220 may be performed by an antenna panel communications manager 630 as described with reference to FIG. 6.

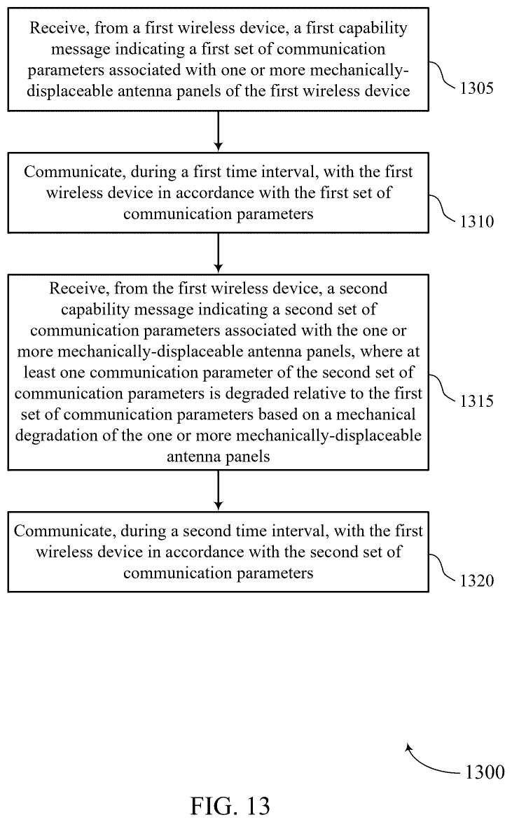

FIG. 13 shows a flowchart illustrating a method 1300 that supports techniques for mitigating motor failure for devices with mechanically displaceable antenna panels in accordance with one or more aspects of the present disclosure. The operations of the method 1300 may be implemented by a network entity or its components as described herein. For example, the operations of the method 1300 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1305, the method may include receiving, from a first wireless device, a first capability message indicating a first set of communication parameters associated with one or more mechanically-displaceable antenna panels of the first wireless device. The operations of 1305 may be performed in accordance with examples as disclosed herein. In some examples, aspects of the operations of 1305 may be performed by a capability message receiving manager 1025 as described with reference to FIG. 10.

At 1310, the method may include communicating, during a first time interval, with the first wireless device in accordance with the first set of communication parameters. The operations of 1310 may be performed in accordance with examples as disclosed herein. In some examples, aspects of the operations of 1310 may be performed by a wireless device communicating manager 1030 as described with reference to FIG. 10.

At 1315, the method may include receiving, from the first wireless device, a second capability message indicating a second set of communication parameters associated with the one or more mechanically-displaceable antenna panels, where at least one communication parameter of the second set of communication parameters is degraded relative to the first set of communication parameters based on a mechanical degradation of the one or more mechanically-displaceable antenna panels. The operations of 1315 may be performed in accordance with examples as disclosed herein. In some examples, aspects of the operations of 1315 may be performed by a capability message receiving manager 1025 as described with reference to FIG. 10.

At 1320, the method may include communicating, during a second time interval, with the first wireless device in accordance with the second set of communication parameters. The operations of 1320 may be performed in accordance with examples as disclosed herein. In some examples, aspects of the operations of 1320 may be performed by a wireless device communicating manager 1030 as described with reference to FIG. 10.

The following provides an overview of aspects of the present disclosure:
Aspect 1: A method for wireless communications at a first wireless device, comprising: transmitting, to a second wireless device, a first capability message indicating a first set of communication parameters associated with one or more mechanically-displaceable antenna panels of the first wireless device; communicating, during a first time interval, with the second wireless device using the one or more mechanically-displaceable antenna panels and in accordance with the first set of communication parameters; transmitting, to the second wireless device, a second capability message indicating a second set of communication parameters associated with one or more mechanically-displaceable antenna panels, wherein at least one communication parameter of the second set of communication parameters is degraded relative to the first set of communication parameters based at least in part on a mechanical degradation of the one or more mechanically-displaceable antenna panels; and communicating, during a second time interval, with the second wireless device using the one or more mechanically-displaceable antenna panels and in accordance with the second set of communication parameters.
Aspect 2: The method of aspect 1, wherein communicating during the first time interval is performed in accordance with a set of TCI states, the method further comprising: receiving, from the second wireless device in response to the second capability message, a control message indicating a modified set of TCI states, wherein communicating during the second time interval is performed in accordance with the modified set of TCI states.
Aspect 3: The method of any of aspects 1 through 2, wherein the second set of communication parameters comprises a displacement duration for actuating the one or more mechanically-displaceable antenna panels, the method further comprising: receiving, from the second wireless device in response to the second capability message, control signaling comprising scheduling information for one or more communications to be performed by the first wireless device during the second time interval, wherein the scheduling information is based at least in part on the displacement duration for actuating the one or more mechanically-displaceable antenna panels.
Aspect 4: The method of aspect 3, wherein the one or more communications associated with the scheduling information comprise at least a first communication and a second communication, a duration between the first communication and the second communication is based at least in part on the displacement duration for actuating the one or more mechanically-displaceable antenna panels.
Aspect 5: The method of any of aspects 1 through 4, wherein the first set of communication parameters and the second set of communication parameters comprise a first power consumption and a second power consumption associated with the one or more mechanically-displaceable antenna panels, respectively, the second power consumption is greater than the first power consumption, and communicating during the first time interval is associated with a first quantity or magnitude of mechanical displacements of the one or more mechanically-displaceable antenna panels, and communicating during the second time interval is associated with a second quantity or magnitude of mechanical displacements of the one or more mechanically-displaceable antenna panels that is less than the first quantity or magnitude of mechanical displacements based at least in part on the second power consumption being greater than the first power consumption.
Aspect 6: The method of any of aspects 1 through 5, wherein the first set of communication parameters, the second set of communication parameters, or both, comprise a range of scan angles of the one or more mechanically-displaceable antenna panels, a linear displacement range of the one or more mechanically-displaceable antenna panels, a displacement duration for actuating the one or more mechanically-displaceable antenna panels, a power consumption associated with the one or more mechanically-displaceable antenna panels, a beamforming capability of the one or more mechanically-displaceable antenna panels, or any combination thereof.
Aspect 7: The method of any of aspects 1 through 6, wherein communicating during the first time interval is performed in accordance with a beamforming codebook, and wherein the second capability message indicates an inability of the first wireless device to communicate in accordance with at least a portion of the beamforming codebook, the method further comprising: receiving, from the second wireless device in response to the second capability message, a control message indicating a modified beamforming codebook, wherein communicating during the second time interval is performed in accordance with the modified beamforming codebook.
Aspect 8: The method of any of aspects 1 through 7, wherein the second set of communication parameters comprises a coherent beamforming capability of the one or more mechanically-displaceable antenna panels, one or more beamforming gains associated with the one or more mechanically-displaceable antenna panels, or both.
Aspect 9: The method of any of aspects 1 through 8, further comprising: identifying a change of the first set of communication parameters to the second set of communication parameters based at least in part on the mechanical degradation of the one or more mechanically-displaceable antenna panels, wherein transmitting the second capability message is based at least in part on identifying the change.
Aspect 10: The method of any of aspects 1 through 9, further comprising: identifying a change of a first communication parameter of the first set of communication parameters to a second communication parameter, the second communication parameter included within the second set of communication parameters, wherein transmitting the second capability message is based at least in part on the change satisfying a deviation threshold.
Aspect 11: The method of any of aspects 1 through 10, wherein the first wireless device comprises a CPE, a UE, or both.
Aspect 12: A method for wireless communications at a second wireless device, comprising: receiving, from a first wireless device, a first capability message indicating a first set of communication parameters associated with one or more mechanically-displaceable antenna panels of the first wireless device; communicating, during a first time interval, with the first wireless device in accordance with the first set of communication parameters; receiving, from the first wireless device, a second capability message indicating a second set of communication parameters associated with one or more mechanically-displaceable antenna panels, wherein at least one communication parameter of the second set of communication parameters is degraded relative to the first set of communication parameters based at least in part on a mechanical degradation of the one or more mechanically-displaceable antenna panels; and communicating, during a second time interval, with the first wireless device in accordance with the second set of communication parameters.
Aspect 13: The method of aspect 12, wherein communicating during the first time interval is performed in accordance with a set of TCI states, the method further comprising: transmitting, to the first wireless device in response to the second capability message, a control message indicating a modified set of TCI states, wherein communicating during the second time interval is performed in accordance with the modified set of TCI states.
Aspect 14: The method of any of aspects 12 through 13, wherein the second set of communication parameters comprises a displacement duration for actuating the one or more mechanically-displaceable antenna panels, the method further comprising: transmitting, to the first wireless device in response to the second capability message, control signaling comprising scheduling information for one or more communications to be performed by the first wireless device during the second time interval, wherein the scheduling information is based at least in part on the displacement duration for actuating the one or more mechanically-displaceable antenna panels.
Aspect 15: The method of aspect 14, wherein the one or more communications associated with the scheduling information comprise at least a first communication and a second communication, a duration between the first communication and the second communication is based at least in part on the displacement duration for actuating the one or more mechanically-displaceable antenna panels.
Aspect 16: The method of any of aspects 12 through 15, wherein the first set of communication parameters and the second set of communication parameters comprise a first power consumption and a second power consumption associated with the one or more mechanically-displaceable antenna panels, respectively, the second power consumption is greater than the first power consumption, and communicating during the first time interval is associated with a first quantity or magnitude of mechanical displacements of the one or more mechanically-displaceable antenna panels, and communicating during the second time interval is associated with a second quantity or magnitude of mechanical displacements of the one or more mechanically-displaceable antenna panels that is less than the first quantity or magnitude of mechanical displacements based at least in part on the second power consumption being greater than the first power consumption.
Aspect 17: The method of any of aspects 12 through 16, wherein the first set of communication parameters, the second set of communication parameters, or both, comprise a range of scan angles of the one or more mechanically-displaceable antenna panels, a linear displacement range of the one or more mechanically-displaceable antenna panels, a displacement duration for actuating the one or more mechanically-displaceable antenna panels, a power consumption associated with the one or more mechanically-displaceable antenna panels, a beamforming capability of the one or more mechanically-displaceable antenna panels, or any combination thereof.
Aspect 18: The method of any of aspects 12 through 17, wherein communicating during the first time interval is performed in accordance with a beamforming codebook, and wherein the second capability message indicates an inability of the first wireless device to communicate in accordance with at least a portion of the beamforming codebook, the method further comprising: transmitting, to the first wireless device in response to the second capability message, a control message indicating a modified beamforming codebook, wherein communicating during the second time interval is performed in accordance with the modified beamforming codebook.
Aspect 19: The method of any of aspects 12 through 18, wherein the second set of communication parameters comprises a coherent beamforming capability of the one or more mechanically-displaceable antenna panels, one or more beamforming gains associated with the one or more mechanically-displaceable antenna panels, or both.
Aspect 20: The method of any of aspects 12 through 19, wherein the first wireless device comprises a CPE, a UE, or both.
Aspect 21: A first wireless device comprising one or more memories storing processor-executable code, and one or more processors coupled with the one or more memories and individually or collectively operable to execute the code to cause the first wireless device to perform a method of any of aspects 1 through 11.
Aspect 22: A first wireless device comprising at least one means for performing a method of any of aspects 1 through 11.
Aspect 23: A non-transitory computer-readable medium storing code the code comprising instructions executable by one or more processors to perform a method of any of aspects 1 through 11.
Aspect 24: A second wireless device comprising one or more memories storing processor-executable code, and one or more processors coupled with the one or more memories and individually or collectively operable to execute the code to cause the second wireless device to perform a method of any of aspects 12 through 20.
Aspect 25: A second wireless device comprising at least one means for performing a method of any of aspects 12 through 20.
Aspect 26: A non-transitory computer-readable medium storing code the code comprising instructions executable by one or more processors to perform a method of any of aspects 12 through 20.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first wireless device, comprising:
one or more memories storing processor-executable code; and
one or more processors coupled with the one or more memories and individually or collectively operable to execute the code to cause the first wireless device to:
transmit, to a second wireless device, a first capability message indicating a first set of communication parameters associated with one or more mechanically-displaceable antenna panels of the first wireless device;
communicate, during a first time interval, with the second wireless device using the one or more mechanically-displaceable antenna panels and in accordance with the first set of communication parameters;
transmit, to the second wireless device, a second capability message indicating a second set of communication parameters associated with the one or more mechanically-displaceable antenna panels, wherein at least one communication parameter of the second set of communication parameters is degraded relative to the first set of communication parameters based at least in part on a mechanical degradation of the one or more mechanically-displaceable antenna panels; and
communicate, during a second time interval, with the second wireless device using the one or more mechanically-displaceable antenna panels and in accordance with the second set of communication parameters.

2. The first wireless device of claim 1, wherein communications during the first time interval are performed in accordance with a set of transmission configuration indicator (TCI) states, wherein the one or more processors are individually or collectively further operable to execute the code to cause the first wireless device to:
receive, from the second wireless device in response to the second capability message, a control message indicating a modified set of TCI states, wherein communicating during the second time interval is performed in accordance with the modified set of TCI states.

3. The first wireless device of claim 1, wherein the second set of communication parameters comprises a displacement duration for actuating the one or more mechanically-displaceable antenna panels, wherein the one or more processors are individually or collectively further operable to execute the code to cause the first wireless device to:
receive, from the second wireless device in response to the second capability message, control signaling comprising scheduling information for one or more communications to be performed by the first wireless device during the second time interval, wherein the scheduling information is based at least in part on the displacement duration for actuating the one or more mechanically-displaceable antenna panels.

4. The first wireless device of claim 3, wherein the one or more communications associated with the scheduling information comprise at least a first communication and a second communication, wherein a duration between the first communication and the second communication is based at least in part on the displacement duration for actuating the one or more mechanically-displaceable antenna panels.

5. The first wireless device of claim 1,
wherein the first set of communication parameters and the second set of communication parameters comprise a first power consumption and a second power consumption associated with the one or more mechanically-displaceable antenna panels, respectively, wherein the second power consumption is greater than the first power consumption,
wherein communications during the first time interval are associated with a first quantity or magnitude of mechanical displacements of the one or more mechanically-displaceable antenna panels, and wherein communications during the second time interval are associated with a second quantity or magnitude of mechanical displacements of the one or more mechanically-displaceable antenna panels that is less than the first quantity or magnitude of mechanical displacements based at least in part on the second power consumption being greater than the first power consumption.

6. The first wireless device of claim 1, wherein the first set of communication parameters, the second set of communication parameters, or both, comprise a range of scan angles of the one or more mechanically-displaceable antenna panels, a linear displacement range of the one or more mechanically-displaceable antenna panels, a displacement duration for actuating the one or more mechanically-displaceable antenna panels, a power consumption associated with the one or more mechanically-displaceable antenna panels, a beamforming capability of the one or more mechanically-displaceable antenna panels, or any combination thereof.

7. The first wireless device of claim 1, wherein communications during the first time interval are performed in accordance with a beamforming codebook, and wherein the second capability message indicates an inability of the first wireless device to communicate in accordance with at least a portion of the beamforming codebook, wherein the one or more processors are individually or collectively further operable to execute the code to cause the first wireless device to:
receive, from the second wireless device in response to the second capability message, a control message indicating a modified beamforming codebook, wherein communications during the second time interval are performed in accordance with the modified beamforming codebook.

8. The first wireless device of claim 1, wherein the second set of communication parameters comprises a coherent beamforming capability of the one or more mechanically-displaceable antenna panels, one or more beamforming gains associated with the one or more mechanically-displaceable antenna panels, or both.

9. The first wireless device of claim 1, wherein the one or more processors are individually or collectively further operable to execute the code to cause the first wireless device to:
identify a change of the first set of communication parameters to the second set of communication parameters based at least in part on the mechanical degradation of the one or more mechanically-displaceable antenna panels, wherein transmitting the second capability message is based at least in part on identifying the change.

10. The first wireless device of claim 1, wherein the one or more processors are individually or collectively further operable to execute the code to cause the first wireless device to:
identify a change of a first communication parameter of the first set of communication parameters to a second communication parameter, the second communication parameter included within the second set of communication parameters, wherein transmitting the second capability message is based at least in part on the change satisfying a deviation threshold.

11. The first wireless device of claim 1, wherein the first wireless device comprises a customer premises equipment (CPE), a user equipment (UE), or both.

12. A second wireless device, comprising:
one or more memories storing processor-executable code; and
one or more processors coupled with the one or more memories and individually or collectively operable to execute the code to cause the second wireless device to:
receive, from a first wireless device, a first capability message indicating a first set of communication parameters associated with one or more mechanically-displaceable antenna panels of the first wireless device;
communicate, during a first time interval, with the first wireless device in accordance with the first set of communication parameters;
receive, from the first wireless device, a second capability message indicating a second set of communication parameters associated with the one or more mechanically-displaceable antenna panels, wherein at least one communication parameter of the second set of communication parameters is degraded relative to the first set of communication parameters based at least in part on a mechanical degradation of the one or more mechanically-displaceable antenna panels; and
communicate, during a second time interval, with the first wireless device in accordance with the second set of communication parameters.

13. The second wireless device of claim 12, wherein communications during the first time interval are performed in accordance with a set of transmission configuration indicator (TCI) states, wherein the one or more processors are individually or collectively further operable to execute the code to cause the second wireless device to:
transmit, to the first wireless device in response to the second capability message, a control message indicating a modified set of TCI states, wherein communicating during the second time interval is performed in accordance with the modified set of TCI states.

14. The second wireless device of claim 12, wherein the second set of communication parameters comprises a displacement duration for actuating the one or more mechanically-displaceable antenna panels, and the one or more processors are individually or collectively further operable to execute the code to cause the second wireless device to:
transmit, to the first wireless device in response to the second capability message, control signaling comprising scheduling information for one or more communications to be performed by the first wireless device during the second time interval, wherein the scheduling information is based at least in part on the displacement duration for actuating the one or more mechanically-displaceable antenna panels.

15. The second wireless device of claim 14, wherein the one or more communications associated with the scheduling information comprise at least a first communication and a second communication, wherein a duration between the first communication and the second communication is based at least in part on the displacement duration for actuating the one or more mechanically-displaceable antenna panels.

16. The second wireless device of claim 12,
wherein the first set of communication parameters and the second set of communication parameters comprise a first power consumption and a second power consumption associated with the one or more mechanically-displaceable antenna panels, respectively, wherein the second power consumption is greater than the first power consumption,
wherein communications during the first time interval are associated with a first quantity or magnitude of mechanical displacements of the one or more mechanically-displaceable antenna panels, and wherein communications during the second time interval are associated with a second quantity or magnitude of mechanical displacements of the one or more mechanically-displaceable antenna panels that is less than the first quantity or magnitude of mechanical displacements based at least in part on the second power consumption being greater than the first power consumption.

17. The second wireless device of claim 12, wherein the first set of communication parameters, the second set of communication parameters, or both, comprise a range of scan angles of the one or more mechanically-displaceable antenna panels, a linear displacement range of the one or more mechanically-displaceable antenna panels, a displacement duration for actuating the one or more mechanically-displaceable antenna panels, a power consumption associated with the one or more mechanically-displaceable antenna panels, a beamforming capability of the one or more mechanically-displaceable antenna panels, or any combination thereof.

18. The second wireless device of claim 12, wherein communicating during the first time interval is performed in accordance with a beamforming codebook, wherein the second capability message indicates an inability of the first wireless device to communicate in accordance with at least a portion of the beamforming codebook, and the one or more processors are individually or collectively further operable to execute the code to cause the second wireless device to:
transmit, to the first wireless device in response to the second capability message, a control message indicating a modified beamforming codebook, wherein communicating during the second time interval is performed in accordance with the modified beamforming codebook.

19. The second wireless device of claim 12, wherein the second set of communication parameters comprises a coherent beamforming capability of the one or more mechanically-displaceable antenna panels, one or more beamforming gains associated with the one or more mechanically-displaceable antenna panels, or both.

20. The second wireless device of claim 12, wherein the first wireless device comprises a customer premises equipment (CPE), a user equipment (UE), or both.

21. A method for wireless communications at a first wireless device, comprising:
transmitting, to a second wireless device, a first capability message indicating a first set of communication parameters associated with one or more mechanically-displaceable antenna panels of the first wireless device;
communicating, during a first time interval, with the second wireless device using the one or more mechanically-displaceable antenna panels and in accordance with the first set of communication parameters;
transmitting, to the second wireless device, a second capability message indicating a second set of communication parameters associated with the one or more mechanically-displaceable antenna panels, wherein at least one communication parameter of the second set of communication parameters is degraded relative to the first set of communication parameters based at least in part on a mechanical degradation of the one or more mechanically-displaceable antenna panels; and
communicating, during a second time interval, with the second wireless device using the one or more mechanically-displaceable antenna panels and in accordance with the second set of communication parameters.

22. The method of claim 21, wherein communicating during the first time interval is performed in accordance with a set of transmission configuration indicator (TCI) states, the method further comprising:
receiving, from the second wireless device in response to the second capability message, a control message indicating a modified set of TCI states, wherein communicating during the second time interval is performed in accordance with the modified set of TCI states.

23. The method of claim 21, wherein the second set of communication parameters comprises a displacement duration for actuating the one or more mechanically-displaceable antenna panels, the method further comprising:
receiving, from the second wireless device in response to the second capability message, control signaling comprising scheduling information for one or more communications to be performed by the first wireless device during the second time interval, wherein the scheduling information is based at least in part on the displacement duration for actuating the one or more mechanically-displaceable antenna panels.

24. The method of claim 23, wherein the one or more communications associated with the scheduling information comprise at least a first communication and a second communication, wherein a duration between the first communication and the second communication is based at least in part on the displacement duration for actuating the one or more mechanically-displaceable antenna panels.

25. The method of claim 21,
wherein the first set of communication parameters and the second set of communication parameters comprise a first power consumption and a second power consumption associated with the one or more mechanically-displaceable antenna panels, respectively, wherein the second power consumption is greater than the first power consumption,
wherein communicating during the first time interval is associated with a first quantity or magnitude of mechanical displacements of the one or more mechanically-displaceable antenna panels, and wherein communicating during the second time interval is associated with a second quantity or magnitude of mechanical displacements of the one or more mechanically-displaceable antenna panels that is less than the first quantity or magnitude of mechanical displacements based at least in part on the second power consumption being greater than the first power consumption.

26. The method of claim 21, wherein the first set of communication parameters, the second set of communication parameters, or both, comprise a range of scan angles of the one or more mechanically-displaceable antenna panels, a linear displacement range of the one or more mechanically-displaceable antenna panels, a displacement duration for actuating the one or more mechanically-displaceable antenna panels, a power consumption associated with the one or more mechanically-displaceable antenna panels, a beamforming capability of the one or more mechanically-displaceable antenna panels, or any combination thereof.

27. The method of claim 21, wherein communicating during the first time interval is performed in accordance with a beamforming codebook, and wherein the second capability message indicates an inability of the first wireless device to communicate in accordance with at least a portion of the beamforming codebook, the method further comprising:
receiving, from the second wireless device in response to the second capability message, a control message indicating a modified beamforming codebook, wherein communicating during the second time interval is performed in accordance with the modified beamforming codebook.

28. The method of claim 21, wherein the second set of communication parameters comprises a coherent beamforming capability of the one or more mechanically-displaceable antenna panels, one or more beamforming gains associated with the one or more mechanically-displaceable antenna panels, or both.

29. A method for wireless communications at a second wireless device, comprising:
receiving, from a first wireless device, a first capability message indicating a first set of communication parameters associated with one or more mechanically-displaceable antenna panels of the first wireless device;
communicating, during a first time interval, with the first wireless device in accordance with the first set of communication parameters;
receiving, from the first wireless device, a second capability message indicating a second set of communication parameters associated with the one or more mechanically-displaceable antenna panels, wherein at least one communication parameter of the second set of communication parameters is degraded relative to the first set of communication parameters based at least in part on a mechanical degradation of the one or more mechanically-displaceable antenna panels; and
communicating, during a second time interval, with the first wireless device in accordance with the second set of communication parameters.

30. The method of claim 29, wherein communicating during the first time interval is performed in accordance with a set of transmission configuration indicator (TCI) states, the method further comprising:
transmitting, to the first wireless device in response to the second capability message, a control message indicating a modified set of TCI states, wherein communicating during the second time interval is performed in accordance with the modified set of TCI states.
